(19) United States
(12) Patent Application Publication
(10) Pub. No.: US 2014/0200924 A1
(43) Pub. Date: Jul. 17, 2014

(54) SYSTEMS, METHODS, AND MEDIA FOR GENERATING CLAIM SUBMISSIONS

(71) Applicant: HireFamily LLC, Waltham, MA (US)

(72) Inventors: Michael J. Gilbert, Natick, MA (US); Doris E. Kraemer, Lexington, MA (US); Mark P. Gibelli, Boynton Beach, FL (US)

(21) Appl. No.: 14/216,669

(22) Filed: Mar. 17, 2014

Related U.S. Application Data
(63) Continuation-in-part of application No. 13/451,514, filed on Apr. 19, 2012.
(60) Provisional application No. 61/802,302, filed on Mar. 15, 2013.
(60) Provisional application No. 61/477,125, filed on Apr. 19, 2011.

(51) Int. Cl. G06Q 50/22; G06Q 10/10

(52) U.S. Cl. CPC G06Q 50/22; G06Q 10/10
USPC 705/3

(57) ABSTRACT

Systems, methods, and media for generating claim submissions are provided. In some embodiments, the methods comprise: storing in one or more storage devices information regarding a plan of care for a care recipient and caregiver information associated with the plan of care; receiving at one or more hardware processors check-in/check-out information initiated by the caregiver regarding caregiver services for the care recipient, which check-in/check-out information includes verification data based on voice matching or face matching; and generating claim submission information based on the received check-in/check-out information.

### CROSS REFERENCE TO RELATED APPLICATION

This application claims the benefit of U.S. Provisional Patent Application No. 61/802,302, filed Mar. 15, 2013, which is hereby incorporated by reference herein in its entirety, and is a continuation-in-part of U.S. patent application Ser. No. 13/451,514, filed Apr. 19, 2012, which claims the benefit of U.S. Provisional Patent Application No. 61/477,125, filed Apr. 19, 2011, each of which is hereby incorporated by reference herein in its entirety.

### TECHNICAL FIELD

The disclosed subject matter relates to systems, methods, and media generating claim submissions.

### BACKGROUND

The process of administering a plan of care for a care recipient, which may be a family member or relative, can be a daunting and burdensome task. Such a process may involve keeping track of hours and days worked and activities performed each week by one or more independent or home care agency caregivers, and then checking that information against the plan of care to identify and resolve any discrepancies or deficiencies. Such a process may further include the daunting and burdensome tasks of recordkeeping, preparation of forms and documentation, and submission of claims to insurance companies and/or other payers of the care provided, such as, for example, government entities and/or their designated representatives or organizations. Moreover, all of this may need to be done unexpectedly when, for example, a sudden illness or injury of a family member or relative occurs.

### SUMMARY

Systems, methods, and media for generating claim submissions are provided. In some embodiments, methods for generating claim submissions are provided, the methods comprising: storing in one or more storage devices information regarding a plan of care for a care recipient and caregiver information associated with the plan of care; receiving at one or more hardware processors check-in/check-out information initiated by the caregiver regarding caregiver services for the care recipient, which check-in/check-out information includes verification data based on voice matching or face matching; and generating claim submission information based on the received check-in/check-out information.

In some embodiments, systems for generating claim submissions are provided, the systems comprising: at least one hardware processor that: stores in one or more storage devices information regarding a plan of care for a care recipient and caregiver information associated with the plan of care; receives check-in/check-out information initiated by the caregiver regarding caregiver services for the care recipient, which check-in/check-out information includes verification data based on voice matching or face matching; and generates claim submission information based on the received check-in/check-out information.

In some embodiments, non-transitory computer-readable media containing computer-executable instructions that, when executed by a processor, cause the processor to perform a method for generating claim submissions are provided, the method comprising: storing in one or more storage devices information regarding a plan of care for a care recipient and caregiver information associated with the plan of care; receiving at one or more hardware processors check-in/check-out information initiated by the caregiver regarding caregiver services for the care recipient, which check-in/check-out information includes verification data based on voice matching or face matching; and generating claim submission information based on the received check-in/check-out information.

### BRIEF DESCRIPTION OF THE DRAWINGS

FIG. 1 is a diagram illustrating an example of a system for implementing an integrated timecard, quality assurance, and claim submission service in accordance with some embodiments;

FIG. 2 is a diagram illustrating another example of a system for implementing an integrated timecard, quality assurance, and claim submission service in accordance with some embodiments;

FIG. 3 is a flow diagram illustrating an example of a process for implementing an integrated timecard, quality assurance, and claim submission service in accordance with some embodiments;

FIG. 4 is a flow diagram illustrating an example of a telephonic check-in/check-out procedure of a timecard process in accordance with some embodiments;

FIG. 5 is an example of a display screen of a timecard process report indicating discrepancies as determined by one or more hardware processors in accordance with some embodiments;

FIG. 6 is a flow diagram illustrating an example of another process for implementing an integrated timecard, quality assurance, and claim submission service in accordance with some embodiments of the invention;

FIG. 7 is an example of a user interface for logging-in in accordance with some embodiments;

FIGS. 8-12 are examples of user interfaces for checking-in in accordance with some embodiments;

FIG. 13 is an example of a user interface for alerting family members of care recipients of check-in/check-out information in accordance with some embodiments;

FIGS. 14-17 are examples of user interfaces for checking-out in accordance with some embodiments;

FIGS. 17-20 are examples of user interfaces for history information of current and previous service periods in accordance with some embodiments; and

FIGS. 21-22 are examples of user interfaces for submitting reports of services worked in accordance with some embodiments.

### DETAILED DESCRIPTION

Systems, methods, and media generating claim submissions are disclosed. In some embodiments, these systems, methods, and media may help families and/or others manage the care of a care recipient in accordance with a pre-established plan of care. In some embodiments, the care recipient may be, for example, an elderly, disabled, or injured family member that needs assistance with everyday living activities such as dressing, bathing, and feeding, either in the care recipient's home or in a care facility. In some embodiments, a plan of care may specify the living activities that a care recipient is to be assisted with by a caregiver. Certain living activities may be referred to as “ADLs” (activities of daily living) and may include bathing, dressing, eating, transferring, mobility, toileting, and maintaining continence. Certain other living activities may be referred to as “IADLs” (instrumental activities of daily living) and may include housekeeping, shopping, meal preparation, companionship, and/or any other suitable service. In some embodiments, a plan of care may specify the number of hours per day and days per week during which the caregiver is to provide that assistance. A caregiver may be, for example, an independent care provider (such as a private home health aide), an employee of a home care agency, an employee of an assisted living facility, a family member or relative, or an informal care provider. A plan of care may be preapproved by an insurance company (e.g., a long-term health care insurer) or other payer (e.g., a government entity such as Medicare or Medicaid or a government-appointed entity) in some embodiments.

An integrated timecard, quality assurance, and claim submission service in some embodiments may be used in a variety of situations. For example, such a service may be used for administering the long term care of an individual in the individual's home, where the individual has a long-term care insurance policy. An employer/client of the service in this situation may be the individual policyholder, the payer may be the long-term care insurer, and the caregiver may be, for example, an independent care provider, an agency caregiver, family member, or relative. The service may also be used for administering care under Medicaid's self-directed care program. Here, the employer/client of the service may be the Medicaid recipient receiving care in the home, the payer may be the Medicaid recipient's state Medicaid program, and the caregiver may be an independent care provider. Similarly, the service may be used for administering care under Medicaid's home and community based service waiver program. The employer/client of the service may again be the Medicaid recipient receiving care in the home, the payer may be the state Medicaid program, and the caregiver may be an independent care provider, family member, or relative. The service may also be used for administering care under Medicaid's assisted living waiver program. In this situation, the employer/client may be the Medicaid recipient receiving care in a licensed assisted living facility, the payer may be the recipient's state Medicaid program, and the caregiver may be an independent care provider and/or staff of the assisted living facility. The service may further be used for administering care under a disability or workers' compensation insurance program. The employer/client of the service may be an injured worker or other individual, the payer may be a private insurer, and the caregiver may be an independent care provider, family member, or relative.

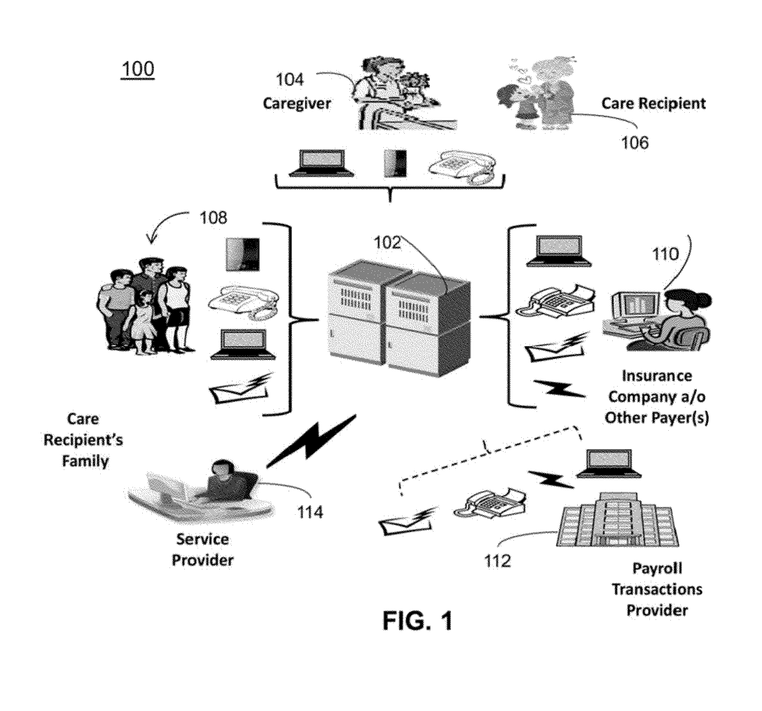

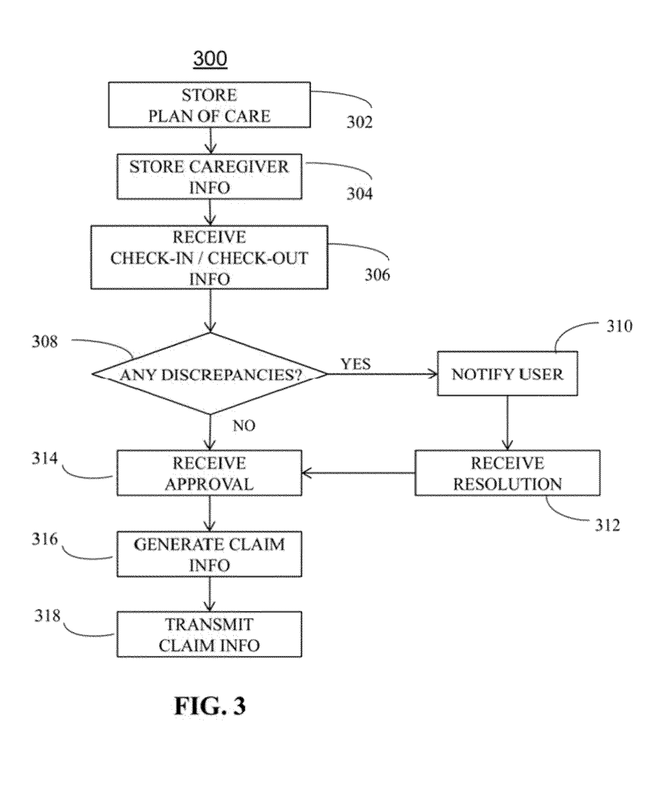

FIG. 1 shows an example of a generalized system 100 that can be used to implement an integrated timecard, quality assurance, and claim submission service in accordance with some embodiments. System 100 may include a computer 102, which may be a general purpose device or a special purpose device, such as a server in a client/server based environment. Computer 102 may be operative to provide (i.e., programmed or configured to perform) a timecard process, a quality assurance process, a claim submission process, and/or an optional payroll process, as described in more detail below in connection with FIGS. 3-6. Computer 102 may include any suitable components such as one or more hardware processors (each of which may be a microprocessor, digital signal processor, controller, etc.), memory, communication interfaces, networking devices, one or more storage devices at least one of which may be suitable for maintaining one or more database systems, display controllers, input/out devices, etc. In some embodiments, at least one hardware processor may have interactive voice response and/or voice recognition/pattern matching capabilities.

Computer 102 may have one or more interfaces for receiving communications from a caregiver 104. Caregiver 104 may access the timecard process of computer 102 to enter check-in/check-out information related to the services provided to a care recipient 106. In some embodiments, caregiver 104 may access the timecard process via a land-line telephone (at, e.g., the home of care recipient 106 or at a facility where care recipient 106 resides), a mobile phone, a smartphone, a personal digital assistant (PDA), a laptop, personal, or tablet computer, or any other suitable mechanism.

Computer 102 may have one or more interfaces for communicating with a care recipient's family 108 or other party responsible for the hiring of caregiver 104. The care recipient's family 108 or other responsible party may be considered to be the client of the integrated timecard, quality assurance, and claim submission service of system 100. In some cases, care recipient 106, if able and willing, may alternatively be the employer/client and, thus, the communication interfaces described herein apply to care recipient 106. In other cases, a caregiver agency may alternatively be the employer/client and, thus, the communication interfaces described herein apply to the caregiver agency (not shown). The timecard, quality assurance, claim submission, and/or optional payroll processes may automatically create various reports and/or notifications (described in more detail below) that are sent or made accessible to the care recipient's family 108 or other responsible party (e.g., a caregiver agency). For example, in some embodiments, the reports or notifications may identify discrepancies and deviations from an expected caregiver schedule or expected results, highlight missing caregiver entries or inaccurate information, indicate a caregiver's hours/days worked and activities performed, and/or provide any other information. In some embodiments, the care recipient's family 108 or other responsible party (e.g., a caregiver agency) may receive, for example, an email, automated phone message, or text message from computer 102 regarding or containing a notification, a report, and/or a direct link to address a specific discrepancy or to view a notification or report. In some embodiments, the care recipient's family 108 or other responsible party may additionally or alternatively have access to a report or notification on a website of system 100 via, for example, a laptop, personal, or tablet computer, a smartphone or PDA application, or any other suitable mechanism. Furthermore, the care recipient's family 108 or other responsible party may transmit information to computer 102. For example, in response to a report or notification, the care recipient's family 108 or other responsible party may provide information that corrects, updates, supplements, verifies, and/or approves information received or generated by the processes performed by computer 102. In some embodiments, the care recipient's family 108 or other responsible party may transmit information to computer 102 via, for example, email, telephone (e.g., via interactive voice prompts and recordings), laptop, personal, or tablet computer, smartphone, PDA, and/or any other suitable mechanism.

Computer 102 may have one or more interfaces for communicating with an insurance company or other payer(s) 110. For example, an insurance company or other payer(s) 110 may transmit an approved plan of care to computer 102 via, for example, direct electronic interface, web interface, fax, email, and/or any other suitable method. Furthermore, claim submission information generated by the claim submission process of computer 102 may be transmitted to the insurance company or other payer(s) 110 via, for example, direct electronic interface, web interface, fax, email, and/or any other suitable method. In some embodiments, for example, there may be a batch or real-time data feed between computer 102 and the insurance company or other payer(s) 110. Receipt of the information by the insurance company or other payer(s) 110 may be confirmed electronically via, for example, direct electronic interface, web interface, fax, email and/or any other suitable method.

In some embodiments in which the optional payroll process is provided, computer 102 may have one or more interfaces for communicating with a payroll transactions provider 112. Payroll transactions provider 112 may be, for example, an EFT (electronic funds transfer) or an ACH (automated clearing house) vendor that may perform bank money transfers based on the payroll information generated by computer 102. Generated payroll information may include information about, for example, withholdings, direct deposits, payment of taxes and fees, year-end statements and filings, and/or any other services related to the compensation of caregiver 104. The generated payroll information may be transmitted from computer 102 to payroll transactions provider 112 via, for example, direct electronic interface, web interface, fax, email, and/or any other suitable method. In some embodiments, for example, there may be a batch or real-time data feed between computer 102 and payroll transactions provider 112. Confirmation of the received information by payroll transactions provider 112 may be transmitted to computer 102 electronically via, for example, direct electronic interface, web interface, fax, email and/or any other suitable method. Note that, in some embodiments, payroll transactions may be performed by computer 102 and, thus, an interface with payroll transactions provider 112 may not be necessary.

Computer 102 may be operated by a service provider 114 of an integrated timecard, quality assurance, and claim submission service in accordance with some embodiments. Service provider 114 may have direct access to the timecard, quality assurance, claim submission, and optional payroll processes via, for example, an input/output device of computer 102. In some embodiments, service provider 114 may store into a database of computer 102 plan of care information received from insurance company 110 (if not automatically stored upon receipt via, e.g., uploading from an insurance company computer) and/or may store caregiver setup information received from care recipient 106, the care recipient's family 108, and/or caregiver 104. Service provider 114 may also, for example, enter information correcting, updating, supplementing, verifying, and/or approving information generated by the timecard, quality assurance, claim submission, and optional payroll processes that, for example, may have been received from care recipient 106 or the care recipient's family 108 in response to one or more reports and/or notifications.

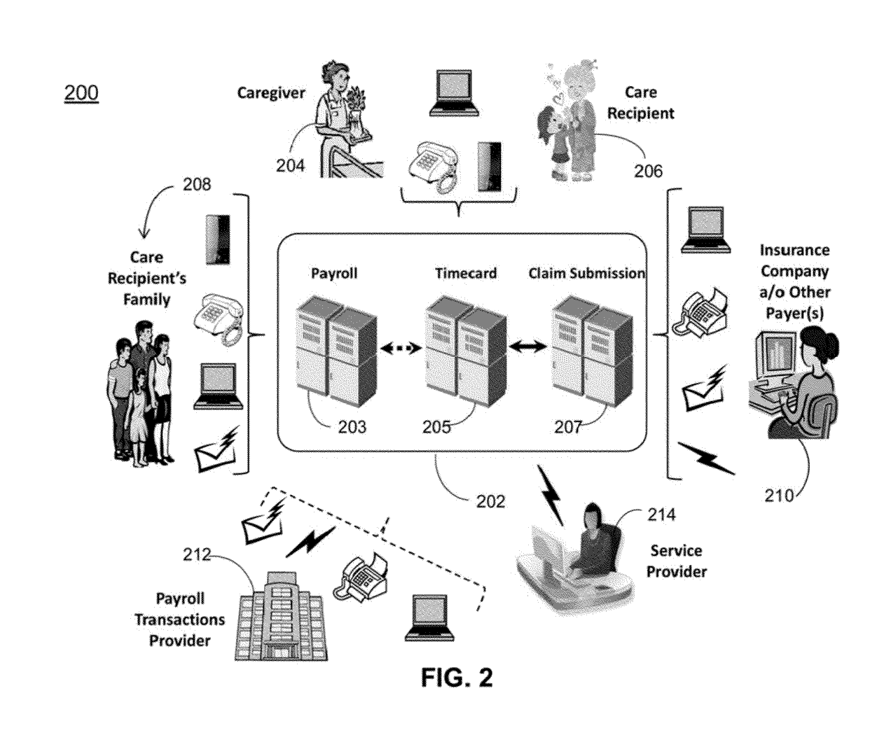

FIG. 2 shows an example of a system 200 that may additionally or alternatively be used to implement an integrated timecard, quality assurance, and claim submission service in accordance with some embodiments. System 200 may include an integrated computer system 202, which may include computers 203, 205, and 207. Computer 203 may be operative to provide a payroll process, which may be optional in some embodiments. Computer 205 may be operative to provide a timecard process, and computer 207 may be operative to provide a claim submission process. Integrated computer system 202 may be operative to provide a quality assurance process that, in some embodiments, may be performed exclusively by any one of computers 203, 205, or 207, or collectively by any combination of computers 203, 205, and 207. For example, each computer may perform a portion of the quality assurance process related to one of the payroll, timecard, or claim submission processes. Payroll, timecard, claim submission, and quality assurance processes in accordance with some embodiments are described in more detail below in connection with FIGS. 3-6.

In some embodiments, computers 203, 205, and 207 are integrated with each other (i.e., all are coupled to and in communication with each other). Each of computers 203, 205, and 207 may be, in some embodiments, a general purpose device or a special purpose device, such as, for example, a web or database server in client/server based environment. Furthermore, in some embodiments, each of computers 203, 205, and 207 may include any suitable components such as one or more hardware processors (which may be a microprocessor, digital signal processor, a controller, etc.), memory, communication interfaces, networking devices, one or more storage devices at least one of which is suitable for maintaining one or more database systems, display controllers, input/out devices, etc. In some embodiments, a hardware processor executing timecard process instructions may have interactive voice response and/or voice recognition/pattern matching capabilities.

In some embodiments, integrated computer system 202 may have one or more interfaces for communicating with each of a caregiver 204, a care recipient 206, the care recipient's family 208, an insurance company or other payer(s) 210, and a payroll transactions provider 212 (i.e., in some embodiments of computer system 202 providing a payroll service). The communication interfaces of computer system 202 may be identical or similar to those described above for the communication interfaces of computer 102 in system 100 (FIG. 1). For example, in some embodiments, caregiver 204 may access the timecard process in computer 205 via, for example, a land-line telephone (at, e.g., the home of care recipient 206), a mobile phone, a laptop, personal, or tablet computer, a smartphone, a PDA, or any other suitable mechanism to enter check-in/check-out information related to the services provided to care recipient 206. In some embodiments, care recipient 206 and/or the care recipient's family 208 or other responsible party (e.g., a caregiver agency) may exchange information with any of computers 203, 205, or 207 in connection with the timecard, claim submission, optional payroll, and quality assurance processes of computer system 202 via, for example, email, telephone (e.g., via interactive voice prompts and recordings), laptop, personal, or tablet computer, smartphone, PDA, and/or any other suitable mechanism. In some embodiments, insurance company or other payer(s) 210 may exchange information with computer 207 via, for example, direct electronic interface, web interface, fax, email, and/or any other suitable method. In some embodiments, for example, there may be a batch or real-time data feed between computer 207 and the insurance company or other payer(s) 210. And payroll transactions provider 212 (in some embodiments having a payroll computer 203 that provides a payroll service) may exchange information with computer 203 via, for example, direct electronic interface, web interface, fax, email, and/or any other suitable method. In some embodiments, for example, there may be a batch or real-time data feed between computer 203 and payroll transactions provider 212. Note that, in some embodiments, payroll transactions may be performed by computer 203 and, thus, an interface with payroll transactions provider 212 may not be necessary.

Integrated computer system 202 may be operated by a service provider 214 of an integrated timecard, quality assurance, and claim submission service in accordance with some embodiments. In some embodiments, service provider 214 may have direct access to the timecard, claim submission, optional payroll, and quality assurance processes via, for example, one or more input/output devices or interfaces of any of computers 203, 205, and 207 as identically or similarly described to that above for computer 102 of system 100 (FIG. 1).

In some embodiments, the integrated timecard, quality assurance, and claim submission service may be a web-based, database centric, n-tier application written in .Net 4.0/C# using an SQL Server 2008R2 database engine and hosted on a Windows Server 2008R2 operating system. The application may run in a virtual Windows Server 2008R2 environment as well as a physical one. Note that, in some embodiments, implementations may be free of features that are dependent upon the use of an SQL Server 2008R2 as the database engine except the physical syntactical definition of the database structure, stored procedures, and triggers. In some embodiments, many of the configuration settings of the application may be setup specifically for an IIS (Internet Information Services) 7.5 Web server environment. In some embodiments, the web-based portion of the application may be HTML 5.0 compliant and may make use of Asynchronous Javascript calls in the user interface (UI) using standard .Net 4.0 functionality and a .Net community supported UI package called Ajax Control Toolkit, available from Microsoft's CodePlex website (http://www.codeplex.com/). The operating system may run on one or more Intel-based server(s) that may be provided by, for example, Dell, Inc. or Hewlett-Packard Company. In some embodiments, multiple redundant database and web servers may be used. A database server may be, for example, a dual-processor/quad-core Intel Xeon based system with 16 GB of RAM and 400 GB of disc space in a RAIDS configuration, and a Web server may be, for example, a dual-processor/dual-core Intel Xeon based system with 8 GB of RAM and 120 GB of disk space in a RAIDS configuration. In some embodiments, Linux servers or other types of hardware and software platforms may be used.

FIG. 3 illustrates an example of a flow diagram of a process 300 for implementing an integrated timecard, quality assurance, and claim submission service in accordance with some embodiments. As shown, at block 302, a hardware processor (of, e.g., computer 102 or integrated computer system 202) may store information regarding a plan of care for a care recipient. The plan of care may be pre-established before a caregiver is hired and may be preapproved by and received from an insurance company or other payer(s) (such as, e.g., insurance company 110 or 210 of FIGS. 1 and 2, respectively), a care recipient (such as, e.g., care recipient 106 or 206), a care recipient's family (such as, e.g., care recipient's family 108 or 208), or a caregiver agency. A plan of care may specify the living activities that a care recipient is to be assisted with by a caregiver, and may specify the number of hours per day and days per week during which the caregiver is to provide that assistance. For example, living activities that a care recipient may be assisted with may include any one or all of the following: bathing, dressing, transporting (e.g., to and from a doctor's office or physical therapy facility), continence, toileting, meal preparation and/or feeding, general supervision/safety, and/or any other appropriate activity, such as, for example, any ADL or IADL. A plan of care may specify, for example, that care is to be provided to a care recipient at the care recipient's home Monday through Friday, from 11:00 am to 8:00 pm. A plan of care may also specify whether the care of the care recipient is to be provided in the care recipient's home or at a care facility, and may include a list of approved caregivers. A plan of care may further specify, for example, the number of hours allowed per assisted activity and/or allowable expenses/mileage that may be incurred by a caregiver.

A plan of care may be received at the hardware processor in a manner and/or format such that, in some embodiments, the hardware processor is operative to automatically store information related to the plan of care in one or more databases of one or more storage devices (such as, e.g., one or more storage devices of computer 102 or computer system 202 of FIGS. 1 and 2, respectively). For example, the plan of care may be uploaded to the hardware processor from an insurance company or other payer computer via direct electronic access. Additionally or alternatively, in some embodiments, a service provider (such as, e.g., service provider 114 or 214 of FIGS. 1 and 2, respectively) may cause the hardware processor to store information related to a plan of care, which may have been received by email, fax, or some other means. In some embodiments, the hardware processor may automatically store one or more portions of the received plan of care, while the service provider may cause the hardware processor to store other portions of the received plan.

In some embodiments, the hardware processor may also store at block 302 customized claim submission information (described in more detail below in connection with block 316) for the insurance company or other payer(s) from which the plan of care was received. This information may specify the types of documents required to be submitted, the file formats of those documents, and the manner in which the claim submission documents are to be sent. For example, in some embodiments, claim submission information may be transmitted to an insurance company or other payer(s) via, for example, direct electronic interface, web interface, fax, email, and/or any other suitable method.

Next, at block 304, a hardware processor may store caregiver information related to the caregiver(s) hired to provide care services to the care recipient. The hardware processor may be the same processor used at block 302 or any other suitable processor of, e.g., computer 102 or integrated computer system 202. The caregiver information may include, for example, the hired caregiver's name, identifier, and/or voice print (i.e., in some embodiments having voice recognition/pattern matching capabilities), a care recipient's name and/or identifier, the care recipient's home telephone number, address, and/or other location information, and/or the name and contact information of the care recipient's family or other party responsible for the hiring of the caregiver. In some embodiments, the caregiver information may include a caregiver work schedule and may be stored on a regular, periodic basis, such as for example, weekly, bi-weekly, or monthly. The caregiver information may also include whether the caregiver provides live-in (i.e., 24 hour/day) or hourly (i.e., less than 24 hour/day) care services to the care recipient. In the case of hourly care services, the caregiver's weekly schedule may be included in the caregiver setup information. The caregiver information may be received entirely or partially from the caregiver, the care recipient, or the care recipient's family or other party responsible for the hiring of the caregiver. The caregiver information may be received at the hardware processor in a manner and/or format such that, in some embodiments, the hardware processor is operative to automatically store the setup information in one or more databases of one or more storage devices. For example, caregiver information may be uploaded to the hardware processor via direct electronic access by a service provider, caregiver, care recipient, care recipient's family or other responsible party. Alternatively or additionally, for example, a caregiver may use an interactive voice response system of the service to input a voice print and other setup information, which is then automatically stored in an appropriate database. In some embodiments, a service provider may cause the hardware processor to store the setup information. In other embodiments, the hardware processor may automatically store one or more portions of the received caregiver information, while the service provider may cause the hardware processor to store other portions of the setup information.

At block 306, a hardware processor executing timecard process instructions may receive check-in/check-out information from a caregiver. This information may be received in some embodiments as services are provided to a care recipient. The hardware processor may be the same processor used at either block 302 or 304 or may be another suitable processor of, e.g., computer 102 or integrated computer system 202. In some embodiments, the caregiver may access the timecard process via, for example, a land-line telephone, a mobile phone, a smartphone, a PDA, a laptop, personal, or tablet computer, or any other suitable mechanism.

In those embodiments where the timecard process is accessible by telephone, the hardware processor executing the timecard process instructions may have interactive voice response capabilities that can answer the telephone call from the caregiver and prompt the caregiver to enter various information. The information may include, for example, a caregiver's identification number and voice input for recording and/or voice recognition, check-in/check-out indications, information about care provided, and/or any other relevant information. In some embodiments, relevant information may include a number of hours worked for each type of service or assistance provided, caregiver expenses, caregiver mileage, a description of services, a message to a care recipient's family or a caregiver's agency, and/or information regarding previous shifts worked. In some embodiments, a timecard process may communicate a message to a caregiver who has called in. For example, a timecard process may provide an outgoing message to a caregiver such as, for example, “you are missing a check-out,” or “you worked 8 hours today.” In some embodiments, a timecard process may communicate a message to a caregiver from the caregiver's agency, a service provider, and/or a care recipient's family. A timecard process may, in some embodiments, provide an outgoing message to all caregivers (or a subset thereof) regarding something applicable to all (or a subset thereof). In some embodiments, the hardware processor may receive the source telephone number of the caller pursuant to a caller identification capability, and may create a time/date stamp of the phone call. The hardware processor may be operative to store some or all of the received and created check-in/check-out information in a database of a storage device (of, e.g., computer 102 or integrated computer system 202). Note that as used herein, “check-in/check-out information” may include some or all of the information collected at block 306.

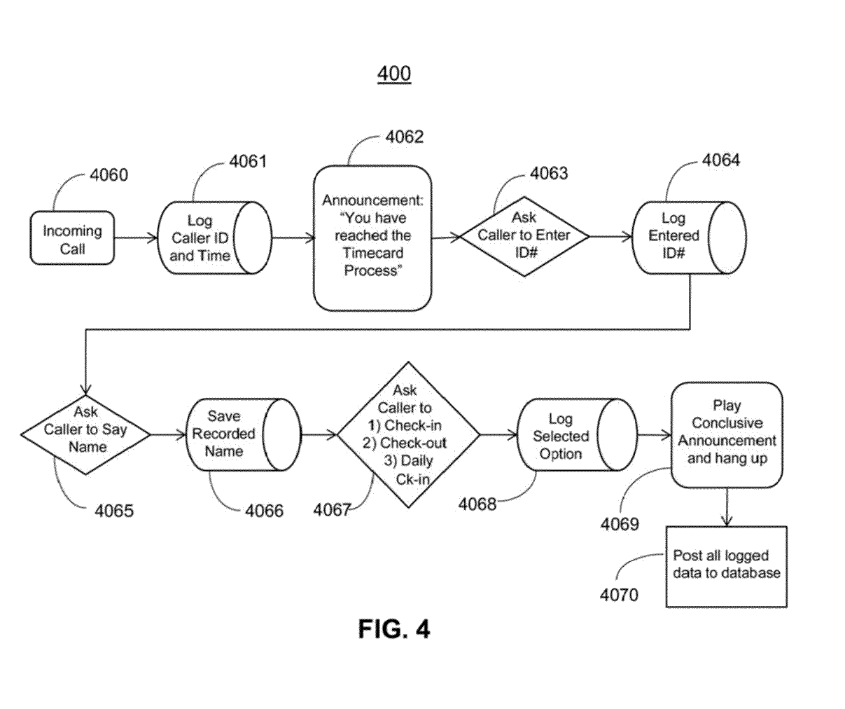

FIG. 4 illustrates an example of a telephonic check-in/check-out process 400 using an interactive voice response capability in accordance with some embodiments. As shown, at 4060, a caregiver may call a telephone call-in number of the timecard process. At 4061, the time card process may log the caller identification number of the telephone from which the caregiver is making the call and may log a time/date stamp of the call. The timecard process may answer the call at 4062 with an announcement identifying the timecard process. At 4063, the caregiver may be prompted to enter a caregiver identification number via a telephone keypad. The process may then repeat back to the caregiver the entered identification number and prompt the caregiver to press “1” on the keypad if correct or “2” on the keypad if incorrect. If “2” is entered, the process may again prompt the caregiver at 4063 to enter a caregiver identification number. In response to pressing “1,” the timecard process may log the entered identification number at 4064. The timecard process may then prompt the caregiver at 4065 to “record your name after the tone.” The process may then repeat back to the caregiver what the caregiver has recorded and prompt the caregiver to again press “1” if correct or “2” if incorrect. If “2” is entered, the process may repeat the prompt to record the caregiver's name. In response to pressing “1,” the timecard process at 4066 may save the recorded name. At 4067, the timecard process may prompt the caregiver to press “1” if recording a shift check-in, press “2” if recording a shift check-out, or press “3” if recording a daily check-in. A daily check-in is used in situations where the caregiver is providing live-in assistance (i.e., 24 hour/per day care) to a care recipient. In response to the caregiver pressing “1,” “2,” or “3,” the process may ask the caregiver to confirm the selection. In response to receiving the confirmation, the timecard process may log the selected option at 4068 and may confirm the selection and end the call at 4069. Note that in other embodiments, other keypad numbers or symbols may be used instead of “1,” “2,” and “3.”

In some embodiments, the timecard process may further voice prompt the caregiver upon check-out or daily check-in, as described above, to provide additional information, such as, for example, the living activities with which the caregiver assisted the care recipient, and/or any other appropriate information. For example, a caregiver may leave a voice message indicating that a care recipient requested additional care hours, approved an early departure by the caregiver, or refused assistance with a particular living activity. Additionally or alternatively, as described above, the timecard process may provide voice messages to a caregiver who telephonically accesses the timecard process.

In some embodiments, the information logged and saved at 4061, 4063, 4066, and 4068 may be written to a temporary file or other locations. When the call is complete, the timecard process may, at 4070, convert the contents of that temporary file to a format suitable for storage in a database.

The call flow of a telephonic timecard process may change, in some embodiments, from that described above in connection with process 400 depending on, for example, the caregiver calling in, a received caller identification number, an associated care recipient or caregiver agency, and/or an associated insurer or other payer. This may occur in cases where different check-in/check-out information needs to be collected.

In some embodiments in which the timecard process is accessed by a web application, such as, for example, via a smartphone, PDA, or laptop, personal, or tablet computer, the hardware processor executing timecard process instructions may receive information submitted by a caregiver via any suitable graphical user interface. The information received may include a caregiver's identification number, voice input for recording and/or voice recognition, shift check-in/check-out indications, information about care provided, and/or any other relevant information including, in some embodiments, the same information as described above in connection with telephonically accessing the timecard process. In some embodiments, a timecard process may provide communications to a caregiver as described above in connection with caregivers who telephonically access the timecard process. The hardware processor may also receive an internet protocol (IP) address (of the source device) of the interaction, and create a time/date stamp of the interaction. In some embodiments, the hardware processor may additionally or alternatively receive global positioning system (GPS) information from any suitably-equipped device used by a caregiver to submit check-in/check-out information. In some embodiments, location information (e.g., GPS information) may be received and/or monitored during any portion of a caregiver shift and/or at any point in time at which a caregiver interacts with the timecard process. The hardware processor may be operative to store all of the received and created information in a database of a storage device (of, e.g., computer 102 or integrated computer system 202).

In some embodiments, the hardware processor may generate comprehensive reports detailing hours worked by every employee (e.g., caregiver 104 or 204) for every employer/client (e.g., care recipient 106 or 206, care recipient family 108 or 208, or other responsible party). These reports may be accessible to a service provider (e.g., service provider 114 or 214), employers/clients, employees, agencies, and insurers or other payers (e.g., insurance company or other payers 110 or 210) through, for example, email, fax, web, smartphone or PDA application, and/or any other suitable mechanism.

To generate the comprehensive work reports, a hardware processor executing timecard process instructions may, in some embodiments, automatically associate check-in events and information with corresponding check-out events and information to create a “work shift.” The processor may compare multiple criteria to determine whether check-in and check-out events are related, including the event source, caller identification, caregiver identifier, shift check-in/check-out menu selection, sequence, time/day stamp, and/or any other relevant information. For example, a caregiver may access the timecard process telephonically from a home telephone of a care recipient at 7:00 am to check-in. A time/date stamp may be generated and a caller identification telephone number from the telephone used by the caregiver may be received by the hardware processor. In some embodiments, the processor may determine whether the received caller identification telephone number matches that of the home telephone of the appropriate care recipient based on the caregiver setup information stored at block 304. In some embodiments, the processor may also compare the caregiver's voice recording made during the 7:00 am check-in call with a voice print stored as part of the caregiver setup information. At the end of the shift, the caregiver may access the timecard process telephonically again from the care recipient's home phone at, for example, 3:00 pm to check-out. Again, a time/date stamp may be generated and a caller identification telephone number from the telephone used by the caregiver may be received by the hardware processor. The processor may again determine whether the received caller identification number matches that of the care recipient's home phone and, in some embodiments, may again compare the caregiver's voice recording made during the 3:00 pm check-out call with either the stored voice print, the voice print made at the 7:00 am check-in call, or both. Upon successfully passing these checks, the hardware processor may associate the 7:00 am check-in call with the 3:00 pm check-out call, determine that the caregiver worked 8 hours based on the time/date stamps of the check-in and check-out telephone calls, and accordingly create a work shift record for that day.

At block 308, one or more hardware processors may determine whether the received check-in/check-out information is complete and in conformance with the stored information regarding the plan of care and the stored caregiver information. In some embodiments, the one or more processors may additionally or alternatively determine whether there are questionable and/or unacceptable patterns in the received check-in/check-out information. Such patterns may, in some embodiments, indicate potential fraud or fraudulent behavior. Any of the one or more hardware processors may be a suitable processor used at block 302, 304, or 306 or may be another suitable processor of, e.g., computer 102 or integrated computer system 202. The one or more hardware processors executing quality assurance process instructions automatically determine whether there are discrepancies or deviations in the received caregiver check-in/check-out information and/or questionable and/or unacceptable patterns in the check-in/check-out information received over a period of time. In some embodiments, this process may be run on a once a day basis, a once a week or bi-weekly basis, an as-needed basis (e.g., as check-in/check-out information is received), or on any suitable schedule. The discrepancies or deviations may include, for example, check-in events without an associated check-out event and/or check-out events without an associated check-in event. Such discrepancies may occur, for example, when a caregiver accesses the timecard process to check-in at the start of a shift, but fails to access the timecard process to check-out at the end of the shift, and vice-versa. Such discrepancies may also occur when a caregiver accessing the timecard process to check-in inadvertently presses an incorrect number or symbol on a telephone keypad indicating a check-out, and vice-versa, resulting in back-to-back check-ins or check-outs.

Other discrepancies or deviations that, in some embodiments, the one or more hardware processors may determine include: (1) separate check-in and check-out events for a live-in caregiver who should have only daily check-ins and (2) daily check-ins for a caregiver who should have separate check-in and check-out events. These discrepancies may occur when a caregiver providing live-in assistance accesses the timecard process and inadvertently presses an incorrect number or symbol on a telephone keypad indicating, for example, a shift check-in instead of a daily check-in. Similarly, such discrepancies may occur when a caregiver providing assistance on an hourly basis accesses the timecard process and inadvertently presses an incorrect number or symbol on a telephone keypad indicating, for example, a daily check-in instead of a shift check-in or check-out.

Still other examples of discrepancies or deviations that, in some embodiments, may be determined by the one or hardware processors may include missing or incomplete care events where assistance with a certain number of living activities is expected but not reported. This may occur when a caregiver accesses the timecard process to indicate that assistance with three living activities was provided to a care recipient on a particular day, but stored information regarding the plan of care indicates that assistance with five living activities was required for that care recipient on that particular day. For example, in some cases, for example, assisting with only 2 or 3 ADLs may be a trigger for an insurer that indicates that a care recipient may have recovered sufficiently to no longer be eligible for benefits under the care recipient's insurance policy.

Still more examples of discrepancies or deviations that, in some embodiments, may be determined by the one or hardware processors may include (1) missing care events where a caregiver is expected to work according to, e.g., a stored schedule (received at, e.g., 304) but checks-in late or not at all; (2) corresponding check-ins and check-outs with non-matching caller identification numbers or location information; (3) corresponding check-ins and check-outs with non-matching caregiver voice prints; and (4) check-ins or check-outs with incorrect caller identification numbers or location information.

At block 308, in some embodiments, a quality assurance process may additionally or alternatively analyze the received check-in/check-out data received over a period of time for questionable and/or unacceptable patterns. For example, a caregiver who fairly regularly fails to check-in and check-out on certain days of the week (e.g., Mondays or Fridays) may be identified. Caregivers who do not check-in or check-out properly more than a predetermined number of times over a given period of time may be identified. Other examples of questionable and/or unacceptable patterns may include: (1) reporting less hours worked than expected, (2) inconsistent information provided to a timecard process versus information submitted manually (e.g., on a log sheet), (3) consistent late check-ins and/or late check-outs, and (4) mismatched location information occurring more than a predetermined number of times over a given period of time may be identified. In some embodiments, the analysis may be performed weekly, bi-weekly, monthly, bi-monthly, or on any appropriate schedule.

In response to the one or more hardware processors determining at decision block 308 that there is at least one discrepancy or deviation in the received check-in/check-out information, process 300 may, in some embodiments, proceed to block 310. If no discrepancies or deviations are found at block 308, process 300 may proceed to block 314. In some embodiments, in accordance with rules of a quality assurance process, certain discrepancies or deviations may be deferred for resolution. In these cases, process 300 may proceed to block 314 instead of to block 310. For example, if a single missing check-out were the only discrepancy found, process 300 may proceed to block 314. In some embodiments, the single check-out discrepancy may proceed to block 310 either at a later time with other later found discrepancies or, in some embodiments, may proceed to block 310 in parallel with other check-in/check-out information being processed at block 314. In another example, quality assurance process rules may, in some embodiments, include time-based rules that may be based on, for example, a service level agreement. Thus, if a claim submission, for example, were due by a certain time or day, and a discrepancy were not resolved by then, process 300 may proceed to block 314 without resolving that discrepancy. Upon deferred resolution of a discrepancy, the relevant information associated with that resolved discrepancy may then be further processed in process 300.

At block 310, the one or more hardware processors executing quality assurance process instructions may, in some embodiments, generate a report of the determined discrepancies and deviations. The one or more hardware processors may further notify a user of the discrepancies or deviations found at decision block 308. Depending on the type of discrepancy or deviation, the user may be one or more of the service provider, the caregiver, the care recipient, the care recipient's family or other responsible party, and/or the insurance company or other payer(s). The one or more hardware processors executing quality assurance instructions may, in some embodiments, determine the appropriate action to take based on the type of discrepancy or deviation. Appropriate action may include, for example: (1) automatic notification of a service provider via any suitable one or more electronic methods, such as email, text messages, instant messages, automated telephone call, display of the generated report, etc.; (2) automatic notification of the care recipient's family or other responsible party via any suitable one or more electronic methods, such as email, text messages, instant messages, automated telephone call, etc.; (3) automatic notification of an insurer or other payer(s) via any suitable one or more electronic methods, such as email, text messages, instant messages, automated telephone call, etc.; and/or (4) automatic notification of a caregiver and/or caregiver agency via any suitable one or more electronic methods, such as email, text messages, instant messages, automated telephone call, etc.

For example, in some embodiments, the service provider may be notified of all determined discrepancies and deviations. In another example, if a determined discrepancy is a missing check-out or check-in event, or a daily check-in event instead of separate check-in and check-out events, the one or more hardware processors may, in some embodiments, automatically notify only the service provider and the caregiver. In a further example, if a determined discrepancy is an earlier than expected check-out time, or a less than expected number of living activities assisted with, the one or more hardware processors may, in some embodiments, automatically notify a service provider, a care recipient's family, and a caregiver and/or caregiver agency.

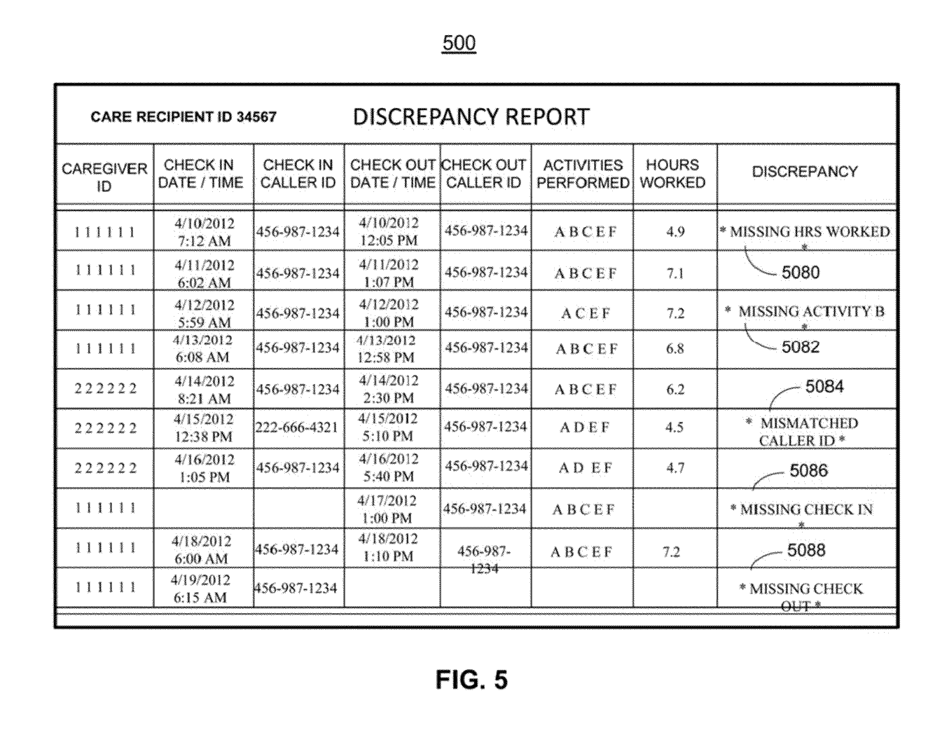

FIG. 5 shows an example of an illustrative discrepancy report 500 that may be generated by the one or more hardware processors in some embodiments. As shown, report 500 may cover a 10-day period for a care recipient having an identifier of 34567 and receiving care from two caregivers, a first caregiver having an identifier of 111111 and a second caregiver having an identifier of 222222. In some embodiments, reports may be generated by the one or more hardware processors that may cover various selectable time periods that may be, for example, one or more days, one or more weeks, and/or one or more months based on selectable dates and/or date ranges. Report 500 may show discrepancies in the check-in/check-out information received from two caregivers. Discrepancy 5080 may indicate that the hours worked on the indicated day by the first caregiver do not conform to the hours that should have been worked on that day as required by the stored plan of care. Discrepancy 5082 may indicate that a living activity “B,” which may be, for example, bathing, was not reported as having been performed by the first caregiver as required by the stored plan of care. Discrepancy 5084 may indicate that mismatched caller identifications were received when the second caregiver checked-in and checked-out. Discrepancy 5086 may indicate that the first caregiver failed to check-in on the indicated day, and discrepancy may 5088 indicates that the first caregiver failed to check-out two days later. Discrepancy reports may be (1) displayed on a display screen of an input/output device of, e.g., computer 102 or computer system 202, (2) accessible at a website of the service via, for example, a laptop, personal, or tablet computer, a smartphone or PDA application, or any other suitable mechanism, (3) attached to a notification email, (4) downloaded to a suitable user device as part of the notification process or as requested by a user, and/or (5) provided to a user in any other suitable manner.

At block 312, the one or more hardware processors may receive information from a user resolving the determined discrepancies and deviations. The user may be, for example, a service provider, a care recipient, a care recipient's family, and/or a caregiver and/or caregiver agency. For example, in response to a notification of discrepancies and deviations, a service provider may manually review a log sheet that the caregiver may have submitted in addition to providing the check-in/check-out information via the timecard process. The log sheet may indicate the dates and times worked and activities performed by a caregiver and may have been approved by the care recipient or care recipient's family prior to submission by the caregiver. The service provider may also compare the automatically determined discrepancies and deviations against the approved plan of care and/or any other information supplied by an insurer in an attempt to resolve the determined discrepancies. Upon resolving a discrepancy, such as, for example, by using the approved log sheet to resolve missing or mismatched check-in and check-out events, the service provider may enter the appropriate information, such as, for example, by editing the appropriate timecard process file(s) to correct, update, and/or supplement the received check-in/check-out information that resulted in the notification of discrepancies and deviations. In other situations, for example, a caregiver, a care recipient, and/or the care recipient's family may respond to a notification of discrepancies and deviations by providing information that corrects, updates, supplements, and/or acknowledges the determined discrepancies and deviations. The information from the caregiver, care recipient, and/or care recipient's family may be provided to the service provider via, e.g., email or fax, wherein the service provider may enter the received information. In some embodiments, users such as the caregiver, care recipient, and/or care recipient's family or other responsible party may provide information resolving one or more discrepancies by editing one or more appropriate files and then uploading the files to the one or more hardware processors or by editing the appropriate file(s) via, for example, a website of the service. In some embodiments, when a user logs onto a website or uses an application to provide updated information (e.g., corrections) in response to a discrepancy notification, that information may be noted in the quality assurance process as a “manual entry,” which may be distinct and discernible from information received via the timecard process. In some embodiments, the quality assurance process may have an “accept as is” feature to be used by one or more authorized users in those cases where the determined discrepancies and deviations are considered minor and/or inconsequential. Additionally or alternatively, based on quality assurance process rules, some discrepancies may not need to be resolved before process 300 can proceed to block 314. For example, a single missing check-out may not prevent process 300 from proceeding to block 314. Upon later resolution of that missing check-out, the relevant information associated with that resolved check-out may be further processed in process 300.

At block 314, the received check-in/check-out information received at block 306, or the check-in/check-out information updated at block 312 to resolve one or more discrepancies determined at block 308 may require user approval before process 300 may proceed to block 316, where claim submission information is generated. This may give a user an opportunity to, for example, manually review reports and information generated by the timecard and quality assurance processes, and/or may allow for additional timecard or quality assurance processing or other information to be received before proceeding with the claim submission process. User approval may be issued by the service provider, the caregiver, the care recipient, and/or the care recipient's family or other responsible party, as may be established by the service provider as part of an overall policy or as determined on a case by case basis where, for example, an employer/client may request that such a user approval be required. In some embodiments, a final quality assurance review may occur at block 314 (additionally or alternatively, a final quality assurance review may occur at block 312). In some embodiments, approval block 314 may be optional and may be omitted from process 300, in which case, process 300 proceeds automatically from the NO branch of decision block 308, and from block 312 directly to block 316 to generate claim submission information.

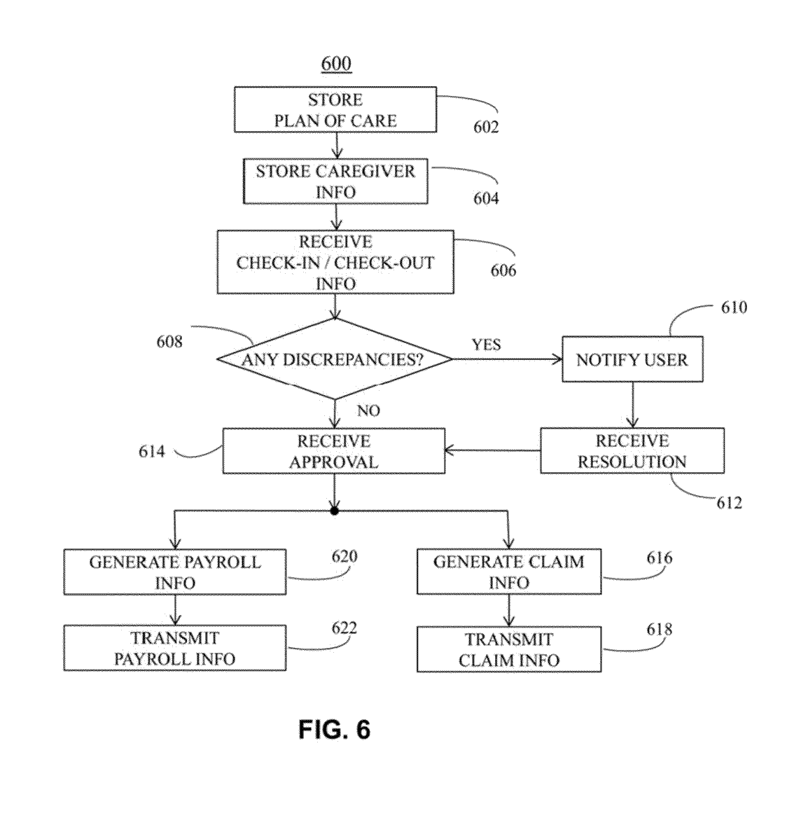

At block 316, one or more hardware processors may execute claim submission process instructions to generate claim submission information based on the received check-in/check-out information from block 306, the updated check-in/check-out information from block 312, or both. The one or more hardware processors may be any suitable processor used to perform one or more of the previously described functions of process 300, or the one or more processors may be one or more other suitable processors of, e.g., computer 102 or integrated computer system 202. In some embodiments, the claim submission process may be run in accordance with a pre-approved schedule per insurance company or other payer(s), or on a weekly or bi-weekly basis, an as-needed basis (as check-in/check-out information is received), or on any other suitable schedule. In some embodiments, the claim submission process may generate various numbers of claim submission documents, invoices, and reports for each employer/client and employee/caregiver, depending on the submission requirements of that employer's/client's insurance company or other payer(s). Records indicating an insurer's and/or payer(s)' required submissions may be stored in a database for each employer/client (e.g., at block 302). In some embodiments, the documents, invoices and reports may be customized for each insurance company or payer. For example, the claim submission process may generate documents using an insurance company's or other payer(s)' pre-approved forms. Some of the documents required by various insurance companies and other payers may be, for example, caregiver log sheets, caregiver invoices, timecard process work reports, quality assurance summary or cover page, and/or discrepancy summary or cover page. Furthermore, different insurers may require different document content. For example, some insurers may require a detailed breakdown of caregiver hours worked, while others may only require a total number of caregiver hours worked. The forms, invoices, reports, and other required documents may be in electronic or paper form as required by the insurer and/or other payer(s). Claim submission information may be generated in various file formats, such as, for example, a coma separated values (CSV) file format, an image file format such as PDF (portable document format), or a page file format. For example, for one insurer, the claim submission process may generate and combine into one PDF claim submission file four different documents (each of which may be multiple pages). The four different documents may be automatically generated using multiple inputs and processes or they may be a manually prepared quality assurance check sheet (prepared by a service provider), a log sheet submitted by the caregiver and approved (e.g., signed) by a care recipient or the care recipient's family, a caregiver invoice, and a caregiver timecard process work report, the last two of which may be generated by either the timecard process or the claim submission process. In some embodiments also having a payroll process (e.g., as described below in connection with FIG. 6), invoices and claim forms for submission to an insurance company and/or other payer(s) may include documents describing all monies paid, including gross wages, state and federal taxes, state and federal fees, payroll fees and/or any other applicable charges or fees, and may include proofs of payment (e.g., cancelled checks) received by a service provider from a caregiver, caregiver agency, care recipient, and/or care recipient's family, as required by an insurer or other payer(s).

At block 318, a hardware processor may transmit claim submission information to an insurance company or other payer(s) in accordance with that insurer's or payer(s)' requirements. These requirements may include the use of an appropriate transmission protocol. For example, in some embodiments, claim submission information may be transmitted via FTP (File Transfer Protocol), Secure Copy (SCP protocol), or Hypertext Transfer Protocol Secure (HTTPS). The transmission may occur automatically pursuant to a schedule or interface agreement, manually via a prompt by a user or some other trigger, and/or on any other suitable basis. Transmission may occur via direct electronic interface, web interface, fax, and/or any other suitable method in accordance with an insurer's or payer(s)' requirements. Records indicating an insurer's and/or payer(s)' required manner of transmission may be stored in a database for each employer/client (e.g., at block 302). Receipt of claim submission information by the insurer or other payer(s) may be confirmed electronically, via direct electronic interface, web interface, fax, email and/or any other suitable method, or manually via web interface, fax, phone, email and/or any other suitable method.

FIG. 6 illustrates an example of a flow diagram of another process for implementing an integrated timecard, quality assurance, and claim submission service in accordance with some embodiments. In contrast to process 300, process 600 includes a payroll process. One or more hardware processors performing process 600 may perform the functions of blocks 602, 604, 606, 608, 610, 612, 614, 616, and 618 in a manner similar or identical to that of blocks 302, 304, 306, 308, 310, 312, 314, 316, and 318 of process 300.

At block 620, a hardware processor may execute payroll process instructions to generate payroll information. Generated payroll information may include information about, for example, caregiver payment, gross wages, withholdings, direct deposits, payment of taxes and fees, year-end statements and filings, and/or any other services related to the compensation of caregiver. In some embodiments, the payroll process may determine when a payroll should be run for each employer/client based on the employer's/client's last payroll date and the frequency of payroll. Payroll frequency can be weekly, bi-weekly, semi-monthly, monthly, ad-hoc or other frequency as requested by the employer/client. In some embodiments, the process can generate the payroll amounts to be paid based on timecard process results and/or other applicable factors. The payroll process may be accessed via any suitable one or more electronic means, including web-based, smartphone application and/or other suitable mechanism. Timecard process information and other payroll details (e.g., hourly wage rates, overtime rates, etc.) can be loaded into the payroll hardware processor automatically or manually, and this can trigger multiple actions within the payroll process, such as, for example: (1) the employer/client and/or designee(s) may be notified of payroll details and amounts via an electronic interface and/or any other applicable mechanism; (2) the employer/client and/or designee(s) may have access to view and change payroll details and amounts via an electronic interface and/or any other applicable mechanism; (3) the information can be stored and retained within a database and may be accessible by a service provider via one or more suitable reports and/or electronic interfaces; and/or (4) the payroll process may perform standard payroll operations according to an appropriate schedule, including generation of information regarding transfer of net pay from employer/client to employees (e.g., caregivers), withholding of income taxes, payment of employer taxes, payment of federal and state fees, payment of payroll fees, printing of receipts and check statements, and/or any other suitable payroll processes.

Additionally, at block 620, the payroll process may, in some embodiments, generate reports of payroll results for individual employers/clients and their caregivers for use in a detailed quality assurance review in addition to those performed at blocks 608 and 614. Results from the timecard and payroll processes may be compared against each other for accuracy, may be compared against log sheets submitted by the caregivers, and may be compared against the approved plan of care and/or any other information supplied by an insurer.

At block 622, the generated payroll information may be transmitted to a third party payroll transactions provider, such as, for example, payroll transactions providers 112 and 212 of FIGS. 1 and 2, respectively. A third party payroll transactions provider may perform the bank money transfers between accounts based on the generated payroll information. The generated payroll information may be transmitted to the payroll transactions provider via, for example, direct electronic interface, web interface, fax, email, and/or any other suitable method. Records indicating a payroll transactions provider's required manner of transmission may be stored in a database. Confirmation of the received information by payroll transactions provider may be transmitted to the hardware processor electronically via, for example, direct electronic interface, web interface, fax, email and/or any other suitable method. In some embodiments, payroll transactions may be performed at block 620 by the payroll process and, accordingly, block 622 may be omitted from process 600.

Note that the steps of the flow diagrams in FIGS. 3, 4, and 6 may be executed or performed in an order or sequence other than the order and sequence shown in the FIGS and described above. For example, some of the steps may be executed or performed substantially simultaneously or in parallel where appropriate to reduce latency and processing times. In some embodiments, one or more steps of these flow diagrams may be omitted.

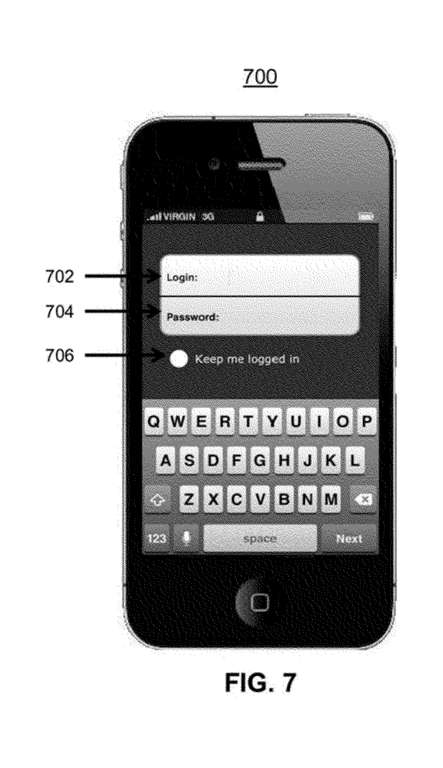

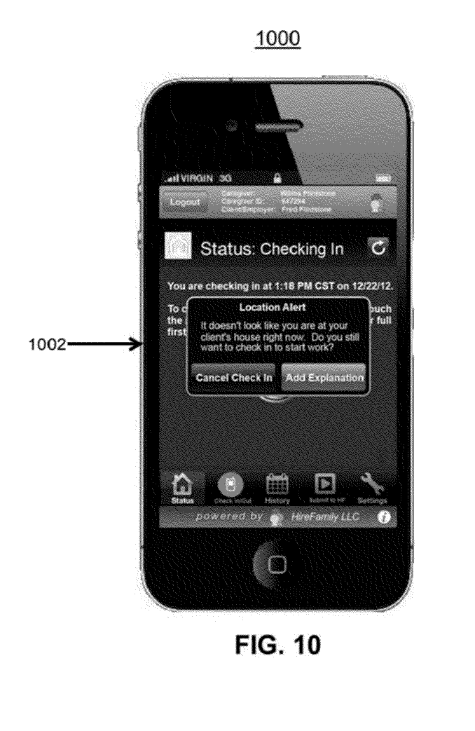

FIGS. 7-22 show examples of user interfaces that can be used in accordance with some embodiments. These user interfaces may be presented by a hardware processer of any suitable device, such as a mobile device (e.g., a mobile phone, a tablet computer, a laptop computer, a personal data assistant, a portable email device, etc.).

Turning to FIG. 7, using a user interface 700 that may be presented by a hardware processor of a mobile device, the hardware processor can receive login information from a caregiver, in some embodiments. The hardware processor can receive login information from a caregiver in any suitable manner. For example, as shown in user interface 700, the hardware process can receive login information using a login field 702 and a password field 704 in which a caregiver can enter his or her user login information. More particularly, for example, the hardware processor can receive login information in the form of a caregiver's identification number entered in login field 702 and a corresponding password entered in password field 704. In some embodiments, “keep me logged in” button 706 can be provided in user interface 700 to allow the hardware process to receive a caregiver's request to keep the caregiver logged in after a given period of inactivity. In some embodiments, password 704 can be a claimant's home phone number on record with the service. In some other embodiments, if the caregiver is an agency caregiver, a single caregiver identification number can be used for all of the agency's caregivers. In some embodiments, the hardware processor can recognize a unique identifier (e.g., such as a phone number or phone identification). For example, the phone number or phone identification can be stored in any suitable storage device in lieu of entering a password.

Upon a successful login, the hardware processor can ensure that a global positioning system receiver (GPS) coupled to or part of a mobile device is enabled. In some embodiments, if the GPS is not enabled, the hardware processor may cause the caregiver to be prompted to enable the GPS. In some embodiments, if the GPS is enabled, the hardware can retrieve location information (e.g., geo-coordinates) from the GPS. This location information can be received constantly or at any suitable frequency. For example, in some embodiments, the hardware processor can retrieve location information periodically (e.g., once per minute). In some embodiments, the hardware processor can store retrieved location information while the caregiver is checked-in and determine what percentage of time the caregiver is at the care recipient's home and what percentage of the time the caregiver is not at the care recipient's home.

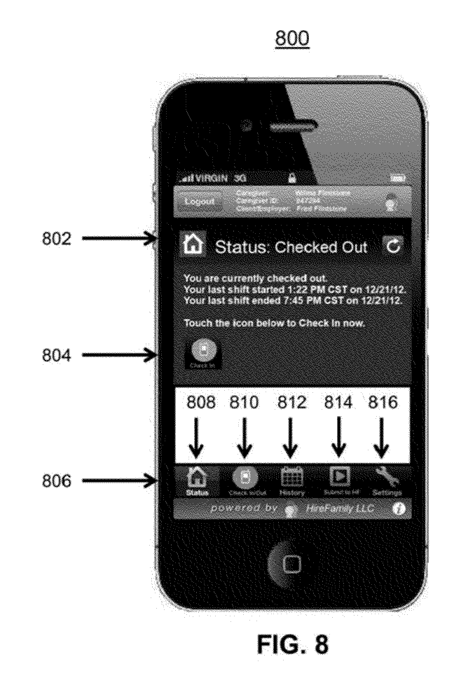

As shown in FIG. 8, using a user interface 800 that may be presented by a hardware processor of a mobile device, the hardware processor can indicate whether the caregiver is checked-in or checked-out in area 802. For example, if the caregiver is checked-out, area 802 can present a “Status: Checked-out” indication. Additionally or alternatively, the hardware processor can present a red icon in area 802 if the caregiver is checked-out and/or present a green icon in area 802 if the caregiver is checked-in.

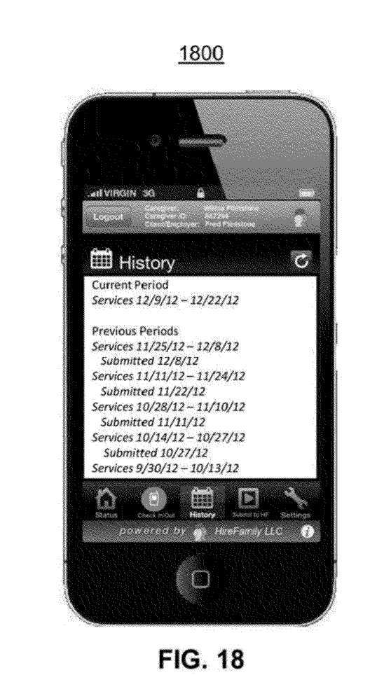

In some embodiments, the hardware processor can present icons in a menu bar 806 of user interface 800 to enable the caregiver to navigate to other user interfaces. Any suitable icons for navigating to any suitable user interface(s) can be provided in some embodiments. For example, in some embodiments, the hardware processor can present an icon 808 that can be used to navigate to a home/status screen as displayed in FIG. 8. As another example, in some embodiments, the hardware processor can present an icon 810 that can be used to navigate to a user interface through which the caregiver can check-in or check-out and/or verify the caregiver's location and identity. As yet another example, in some embodiments, the hardware processor can present an icon 812 that can be used to navigate to a user interface that presents information on the caregiver's shifts for current processing periods or past processing periods, as shown in FIGS. 18-20. As still another example, in some embodiments, the hardware processor can present an icon 814 that can be used to navigate to a user interface that allows the caregiver to complete processing for the current or previous service period(s) and to submit hours worked for such service period(s) for processing. As still another example, in some embodiments, the hardware processor can present an icon 816 that can be used to navigate to a user interface for changing one or more setting options.

The hardware processor can receive an indication that a caregiver wants to check-in in any suitable manner. For example, in some embodiments, the hardware processor can determine that a caregiver wants to check-in upon it detecting that the caregiver has tapped on area 804. As another example, in some embodiments, the hardware processor can determine that a caregiver wants to check-in upon it detecting that the caregiver has tapped on icon 910. As yet another example, in some embodiments, the hardware processor can also detect that the caregiver wants to check-in by recognizing that the geo-coordinates and locations of the phone match a predetermined area.

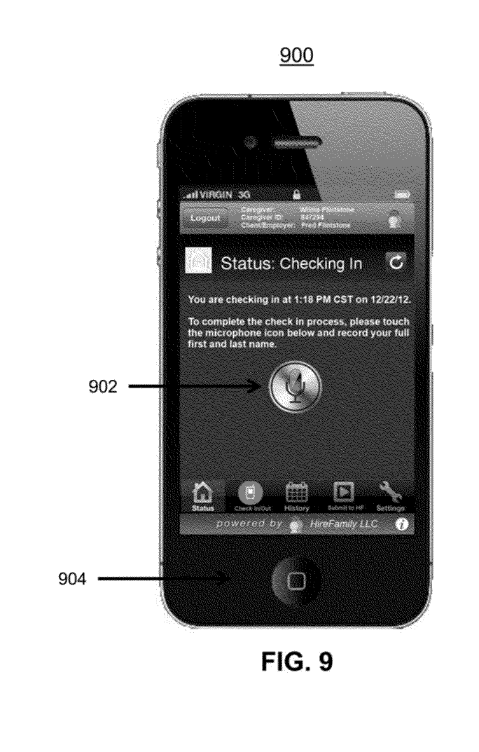

As illustrated in FIG. 9, after it is detected that a user has tapped on area 804 or icon 810, the hardware processor can attempt to verify that the person checking-in is in fact the caregiver. This verification can be performed in any suitable manner. For example, in some embodiments, this verification can be performed by presenting a user interface 900, as shown in FIG. 9.

As illustrated in FIG. 9, in user interface 900, the hardware processor can prompt the caregiver to provide a voice verification by tapping on microphone icon 902 and speaking a name, one or more words, one or more phrases, etc. In response to the caregiver tapping on microphone icon 902, the hardware processor can verify the caregiver's identity by recording his or her voice using a microphone (e.g., the mobile device's built-in microphone) and determining whether that recording matches a known-good recording of the caregiver's voice. This determination can be made in any suitable manner. For example, the hardware process can verify the identity of the caregiver by matching the caregiver's recorded voice with a pre-recorded voice print using any suitable voice recognition technique. In some embodiments, when a caregiver taps on microphone icon 902, the hardware processor can verify the caregiver's identify by capturing an image or facial characteristics of his or her face using a camera (e.g., the mobile device's built-in camera) and determining whether the image or facial characteristics matches a known-good image or facial characteristics of the caregiver's face. This determination can be made in any suitable manner, e.g., using any suitable facial recognition technique. In some embodiments, the hardware processor can prompt the caregiver to provide any suitable fingerprint. In response to the caregiver tapping on button 904, the hardware processor can verify the caregiver's identify by capturing his or her fingerprint using any suitable technique (e.g., the mobile device's fingerprint sensor) and determining whether the recorded fingerprint matches a known-good recording of the caregiver's fingerprint. This determination can be made in any suitable manner. For example, the hardware process can verify the identity of the caregiver by matching the caregiver's recorded fingerprint with a pre-recorded fingerprint using any suitable fingerprint recognition technique. In some embodiments, the hardware processor can prompt the caregiver to provide any suitable unique personal information. For example, unique personal information can include a password, a pin, a pattern, a code, an image, a voice, a fingerprint, and/or any other suitable unique personal information.

In some embodiments, once a caregiver has checked-in, the hardware processor can monitor location information relating to the caregiver to verify that the caregiver is at an expected location. This determination can be made in any suitable manner. For example, this determination can be made by comparing the distance between a GPS indicated location of the caregiver's mobile device and a predetermined location of a care recipient's location (e.g. within a predetermined distance). For example, the distance can be measures in any suitable way.

If it is determined that a caregiver is not at an expected location, the hardware processor can present any suitable notification and/or generate any suitable log entry. For example, in some embodiments, the hardware processor can present a user interface 1000 to indicate that a caregiver does not appear to be at an expected location.

As a more particular example, in some embodiments, if the location of the caregiver's mobile device and the location of the care recipient's house are not within 100 feet of each other, a location mismatch prompt 1002, as shown in user interface 1000, can be presented. For example, using the location mismatch prompt 1002, the hardware processor can ask the caregiver to “Add Explanation” or “Cancel Check-In.” In some embodiments, if “Add Explanation” is chosen, the hardware processor can present a list of predetermined reasons for not being at an expected location for the caregiver to choose from, or can provide the caregiver with a text entry box if “other” is chosen. For example, the list may contain reasons such as “Picking up client outside home (doctor's office),” “Providing services in alternation location,” “Client in hospital,” and/or any other suitable reason. In some embodiments, if “Cancel Check-In” is chosen, the hardware processor can present the home screen without checking-in.

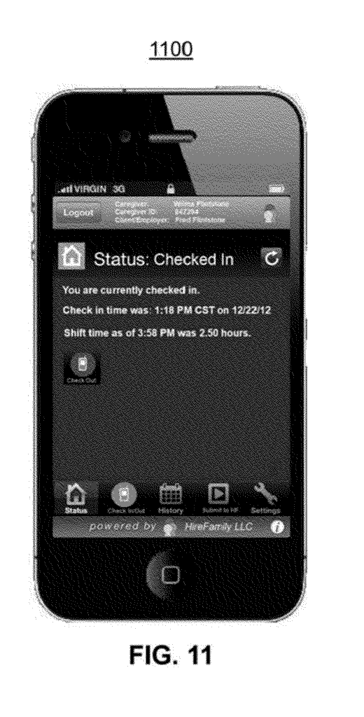

Next, as shown in FIG. 11, using a user interface 1100 that may be presented by a hardware processor of a mobile device, the hardware processor can display current status information. For example, the hardware processor can display “Check-In Time was: 1:18 PM CST on 12/22/12” and “Shift time as of 3:58 PM was 2.50 hours” in user interface 1100.

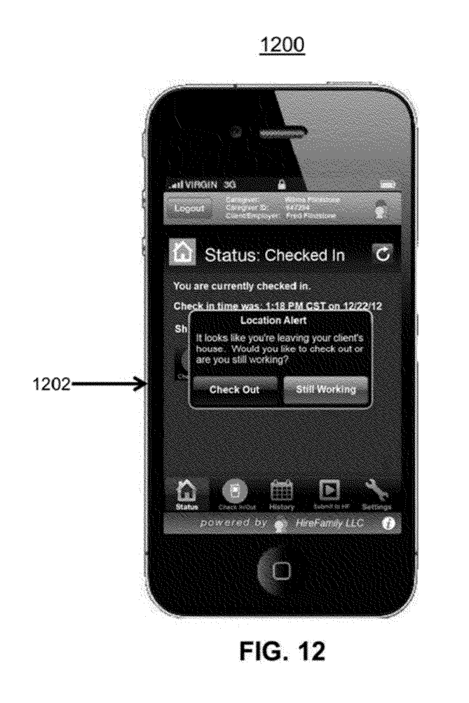

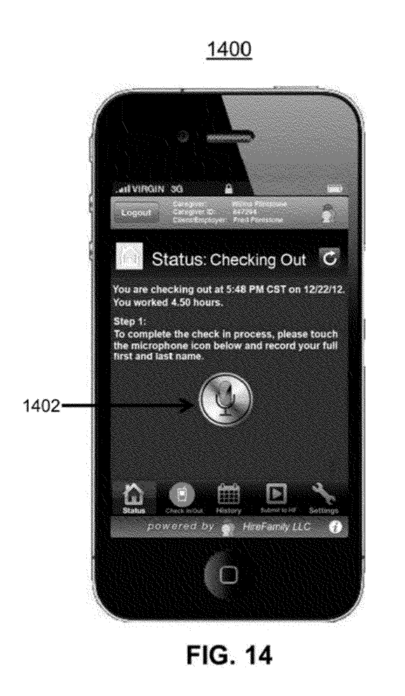

In some embodiments, as shown in FIG. 12, using a user interface 1200 that may be presented by a hardware processor of a mobile device, the hardware processor can display a location alert prompt 1202 if the caregiver moves away from an expected location, such as the care recipient's house. For example, a location alert prompt 1202 can state “It looks like you're leaving your client's house. Would you like to check-out or are you still working?” If the care recipient chooses “Still Working,” the hardware processor can present a list of predetermined reasons for not being at an expected location for the caregiver to choose from, or can provide the caregiver with a text entry box if “other” is chosen. For example, the list may include reasons such as “Running errands for client (Shopping),” “Transporting client to doctor's office,” “Bringing client to hospital,” and/or any other suitable reason. In some embodiments, if “Check-Out” is chosen, the hardware processor can present a check-out screen as shown in user interface 1400 at FIG. 14 and as described below.

In some embodiments, the hardware processor can display a voice/image/fingerprint verification prompt to the caregiver regardless whether or not the caregiver moves away from an expected location. For example, the hardware processor can display a voice/image/fingerprint verification prompt periodically (e.g. once every one hour) or at random times to verify the identity of the caregiver. For example, the hardware process can verify the identity of the caregiver by matching the caregiver's recorded voice with a pre-recorded voice print using any suitable voice recognition technique. In another example, the hardware process can verify the identity of the caregiver by matching the caregiver's recorded fingerprint with a pre-recorded fingerprint using any suitable fingerprint recognition technique. In yet another example, the hardware process can verify the identity of the caregiver by receiving any suitable unique personal identification. In some embodiments, the hardware processor can verify the caregiver's identify by capturing an image or facial characteristics of his or her face using a camera (e.g., the mobile device's built-in camera) and determining whether the image or facial characteristics matches a known-good image of the caregiver's face. This determination can be made in any suitable manner, e.g., using any suitable facial recognition technique. In some embodiments, the hardware processor can display a voice/image/fingerprint verification prompt one or more times during a service period. For example, the hardware processor can display a voice/image/fingerprint verification prompt a predetermined amount of time or any suitable amount of times to verify the identity and/or presence of the caregiver.

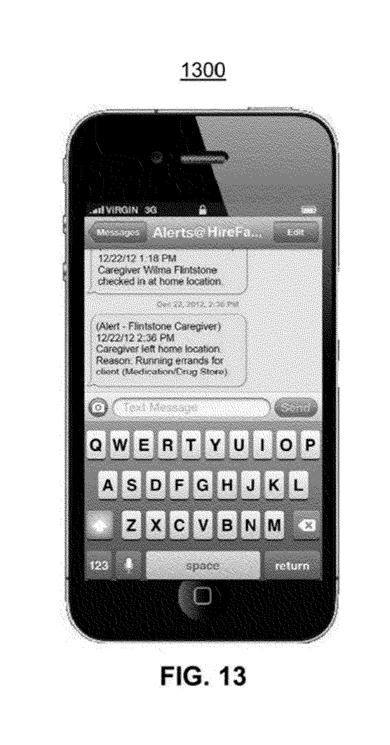

Turning to FIG. 13, using a user interface 1300 that may be presented by a hardware processor of a mobile device, the hardware processor can alert family members of the care recipient when the caregiver checks-in or checks-out. Additionally or alternatively, family members can also be alerted about location mismatch events. For example, the hardware processor can send a text message to a family member of the care recipient saying, “Caregiver left home location. Reason: Running errands for client (Medication/Drug Store).”

Turning to FIGS. 14-17, user interfaces 1400, 1500, 1600, and 1700 that can be presented in connection with a caregiver checking-out are illustrated.

As shown in FIG. 14, in some embodiments, using a user interface 1400 that may be presented by a hardware processor of a mobile device, the hardware processor can present a microphone icon 1402 that can be tapped on by the caregiver to initiate a check-out. In response to the caregiver tapping on icon 1402, the hardware processor can record the caregiver's voice to verify the caregiver's identity using any suitable voice recognition technique. In some embodiments, the hardware processor may additionally or alternatively capture a picture of the caregiver's face or facial characteristics in order to verify the caregiver's identity using any suitable facial recognition technique. In some embodiments, the hardware processor can receive a fingerprint of the caregiver in order to verify the caregiver's identity using any suitable fingerprint recognition technique.

In some embodiments, the hardware processor can determine whether the caregiver is within a predetermined distance of an expected location (e.g., 100 feet of the care recipient's house) before allowing the caregiver to check-out.

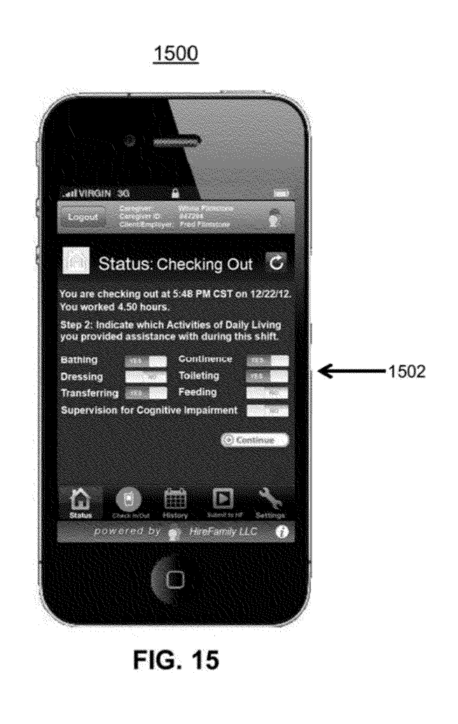

In some embodiments, the hardware processor may prompt a caregiver to provide a list of activities of daily living (ADLs) that have been performed by the caregiver during his or her service period. The list can be prompted for in any suitable manner. For example, as shown in FIG. 15, using a user interface 1500 that may be presented by a hardware processor of a mobile device, the hardware processor can receive from a caregiver a list of ADLs that have been performed by the caregiver during his or her service period. More particularly, for example, this list can be received as a set of yes/no selections from a predetermined list 1502 of ADL check boxes presented by the hardware processor to the caregiver. In some embodiments, the caregiver can tap one or more yes/no options of ADL check boxes (e.g., as shown in user interface 1500) to indicate what care the caregiver provided during his or her shift. For example, the ADLs can include “Bathing,” “Dressing,” “Transferring,” “Continence,” “Toileting,” and “Feeding,” and/or any other suitable ADLs. In some embodiments, the hardware processor may prompt a caregiver to provide a list of activities provided for each ADL. For example, the caregiver can select whether the caregiver provided “Hands-on Assistance,” Standby Assistance,” or “No Assistance,” and/or another other suitable assistance provided for each ADL.

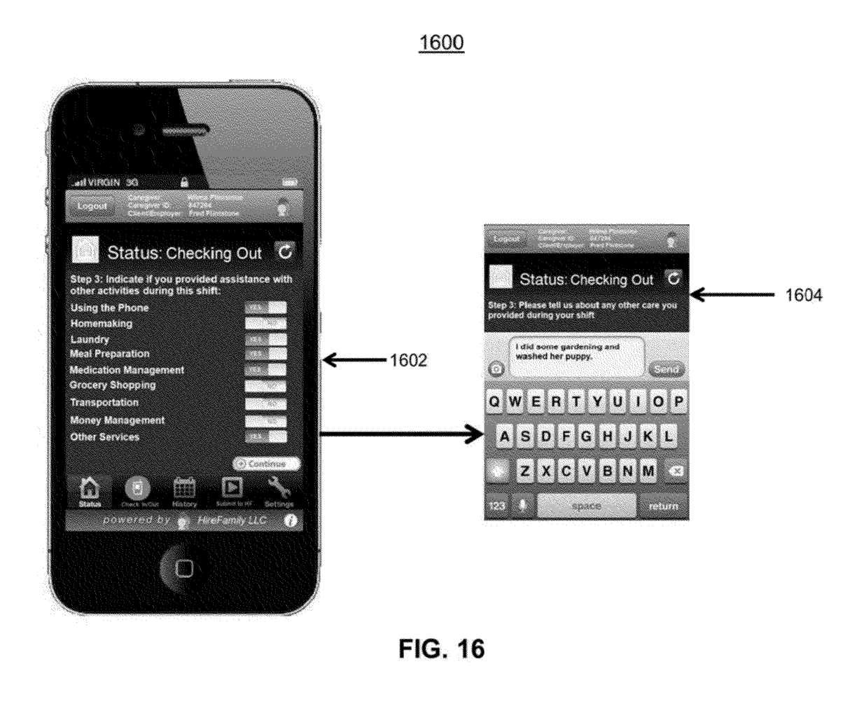

In some embodiments, the hardware processor may prompt a caregiver to provide list of other activities that have been performed by the caregiver during his or her service period. The list can be prompted for in any suitable manner. For example, as shown in FIG. 16, using a user interface 1600 that may be presented by a hardware processor of a mobile device, the hardware processor can receive from a caregiver a list of other activities that have been performed by the caregiver during his or her service period. More particularly, for example, this list can be received as a set of yes/no selections from a predetermined list 1604. Still more particularly, for example, other activities can include “Using the Phone,” “Homemaking,” “Laundry,” “Meal Preparation,” “Medication Management,” “Grocery Shopping,” “Transportation,” “Money Management,” and/or any other suitable activities. In some embodiments, in response to the caregiver selecting an “Other Services” option, the hardware processor can receive from the caregiver a description of “Other Services” the caregiver provided using prompt 1604. For example, the caregiver can type “I did some gardening” in prompt 1602.

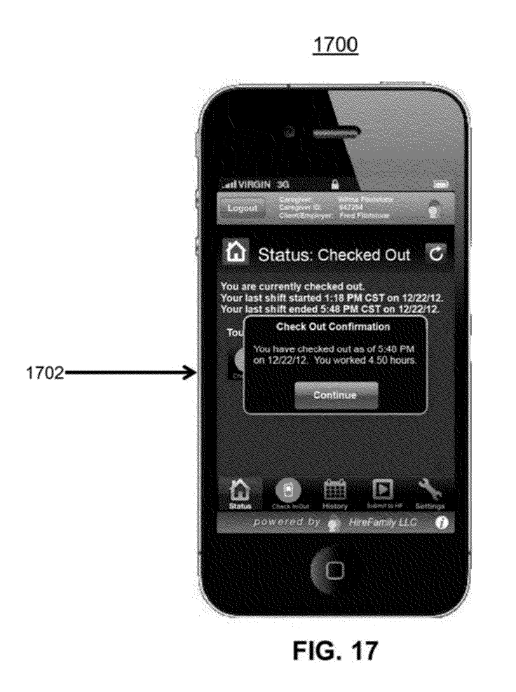

Upon completing a check-out, as shown in FIG. 17, the hardware processor can display Check-Out Confirmation prompt 1702 using a user interface 1700 that may be presented by the hardware processor of a mobile device. For example, Check-Out Confirmation prompt 1702 can state “You have checked-out as of 5:48 PM on 12/22/12. You worked 4.50 hours.” in some embodiments.

As shown in FIG. 18, using a user interface 1800 that may be presented by a hardware processor of a mobile device, the hardware processor can displays a history screen of services provided in a current service period and the services provided in previous service periods. For example, user interface 1800 can display “Current Period. Services 12/9/12-12/22/12.” In another example, user interface 1800 can display “Previous Periods. Services 11/25/12-12/8/12. Submitted 12/8/12.”

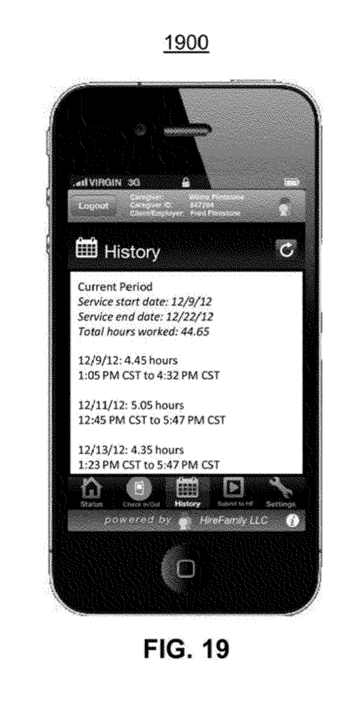

Next, at FIG. 19, using a user interface 1900 that may be presented by a hardware processor of a mobile device, the hardware processor can display a detailed history screen of the current service period. In some embodiments, user interface 1900 can show the start and end dates of a specific current service period. For example, user interface 1900 can show the total hours worked by the caregiver during the current service period. More particularly, for example, user interface 1900 can display “12/9/12: 4.45 hours 1:05 PM CST to 4:32 PM CST.” In some embodiments, the hardware processor can allow the caregiver to scroll through a list of shifts the caregiver worked during the current service period.

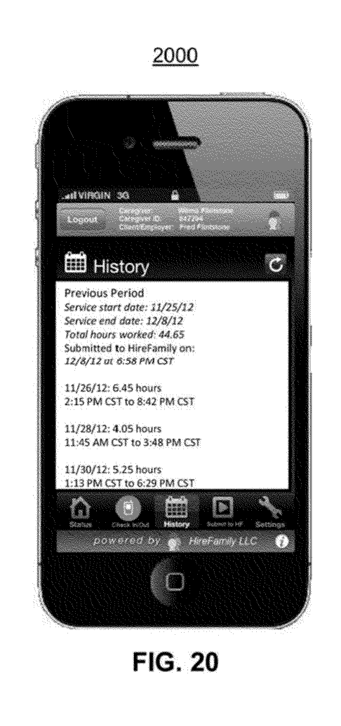

Turning to FIG. 20, using a user interface 2000 that may be presented by a hardware processor of a mobile device, the hardware processor can display a detailed history screen showing a detailed history of work performed during previous service periods. In some embodiments, user interface 2000 can show the start and end dates of a specific previous service period. For example, user interface 2000 can show the total hours worked by the caregiver during previous service periods. For example, user interface 2000 can display “11/26/12: 6:45 hours 2:15 PM CST to 8:42 PM CST.” In some embodiments, the hardware processor can allow the caregiver to scroll through a list of shifts the caregiver worked during the previous service periods.

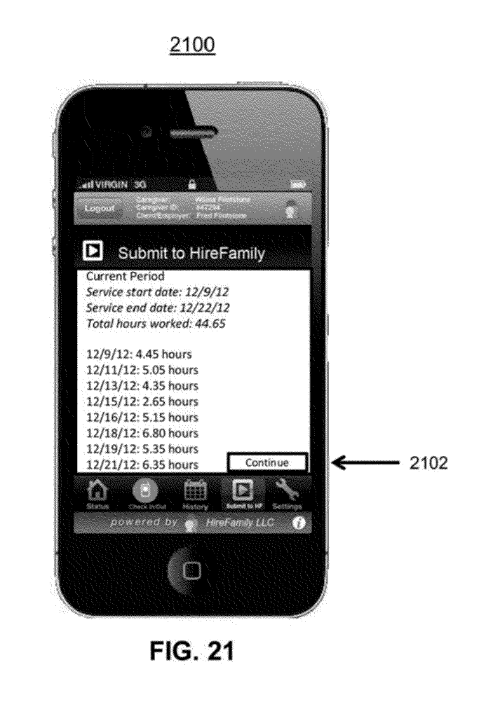

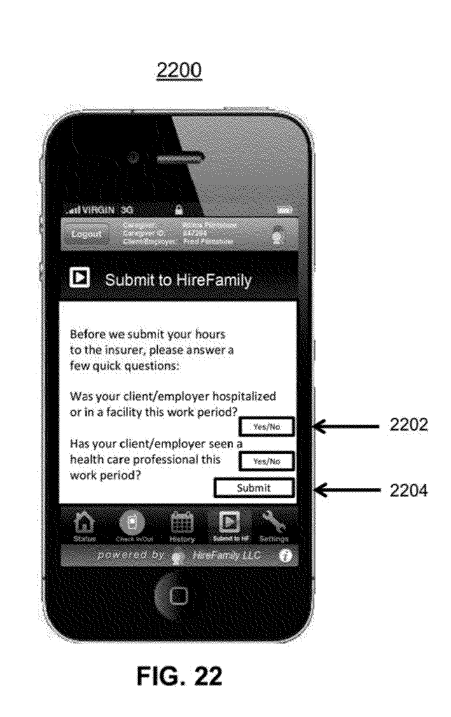

Turning to FIGS. 21-22, user interfaces 2100 and 2200 that can be presented in connection with submitting details of services provided by a caregiver are illustrated.

As shown in FIG. 21, in some embodiments, using a user interface 2100 that may be presented by a hardware processor of a mobile device, the hardware processor can display the start and end dates of the current service period for which details of services provided are to be submitted. For example, in some embodiments, user interface 2100 can show the total hours worked by the caregiver for each day. More particularly, for example, user interface 2100 can display “12/9/12: 4.45 hours.”

As shown in FIG. 22, using a user interface 2200 that may be presented by a hardware processor of a mobile device, the hardware processor can display questions to be answered by a caregiver before submitting hours worked to the service. In response, the caregiver can answer the questions (e.g., by clicking yes/no button 2202) before the hardware processor submits the hours worked to the service. For example, user interface 2200 can display “Was you client/employer hospitalized or in a facility this work period?” and/or “Has your client/employer seen a health care professional this work period?”

In some embodiments, the hardware processor can present a “submit” button 2204 which, when tapped, will cause the hardware processor to submit the total hours worked for the given service period.

Note also that in some embodiments the timecard, claim submission, and quality assurance processes are not necessarily each separate processes with defined boundaries, but may be part of a single integrated process.

In accordance with some embodiments, any of the devices described herein may be any of a general purpose device such as a computer or a special purpose device such as a client, a server, phone, smartphone, mobile phone, web browsing appliance, fax machine, etc. Any of these general or special purpose devices may include any suitable components such as a hardware processor (which may be a microprocessor, digital signal processor, a controller, etc.), memory, communication interfaces, display controllers, input devices, etc.

In some embodiments, any suitable computer readable media may be used for storing instructions for performing the processes described herein. For example, in some embodiments, computer readable media may be transitory or non-transitory. For example, non-transitory computer readable media may include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media may include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention may be made without departing from the spirit and scope of the invention, which is only limited by the claims which follow. Features of the disclosed embodiments may be combined and rearranged in various ways.

What is claimed is:

1. A method comprising:
storing in one or more storage devices information regarding a plan of care for a care recipient and caregiver information associated with the plan of care;
receiving at one or more hardware processors check-in/check-out information initiated by the caregiver regarding caregiver services for the care recipient, which check-in/check-out information includes verification data based on voice matching or face matching; and
generating claim submission information based on the received check-in/check-out information.

2. The method of claim 1, further comprising:
repeatedly receiving location information from a global positioning system over a period of time;
determining whether the location information matches a predetermined area; and
generating an alert and/or checking out the caregiver if it is determined that the location information does not match the predetermined area.

3. The method of claim 1, wherein generating claim submission information comprises generating claim submission information in one of a coma separated values (CSV) file format, a spreadsheet, an image file format, or a page file format.

4. The method of claim 1, further comprising transmitting the claim submission information to an insurer or payer of the caregiver services.

5. The method of claim 4, further comprising transmitting the claim submission information via one of fax, secure copy (SCP) protocol, hypertext transfer protocol secure (HTTPS), file transfer protocol (FTP), or direct electronic interface.

6. The method of claim 1, wherein the storing in one or more storage devices of information regarding a plan of care comprises storing in one or more storage devices information including at least one of a care recipient identifier, a number of caregiver hours to be worked in a day, a number of caregiver days to be worked in a week, or an indication of at least one type of activity of daily living with which the care recipient is to be assisted.

7. The method of claim 1, further comprising determining a number of hours worked and comparing the number of hours worked to a planned number of hours to be worked.

8. The method of claim 1, wherein the storing in one or more storage devices of caregiver information comprises storing in one or more storage devices at least one of a caregiver identifier, a voice print of the caregiver's voice, a previous recording of the caregiver's voice, or an image of the caregiver's face.

9. The method of claim 1, wherein the receiving at one or more hardware processors check-in/check-out information comprises at least one of:
receiving at the one or more hardware processors check-in time information from the caregiver regarding the caregiver services, the check-in time information including at least one of a caregiver identifier, a voice input comprising the caregiver's spoken name, another voice input compared to the voice print, an image of the caregiver's face; or
receiving at the one or more hardware processors check-out time information from the caregiver regarding the caregiver services, the check-out time information including at least one of a caregiver identifier, a voice input comprising the caregiver's spoken name, another voice input compared to the voice print, an image of the caregiver's face, or information about services provided.

10. The method of claim 1, further comprising determining that the received check-in/check-out information is not complete or does not conform to the stored information regarding the plan of care or to the stored caregiver information and notifying a user of one or more discrepancies in the received check-in/check-out information.

11. The method of claim 10, wherein the determining that the received check-in/check-out information is not complete or does not conform to the stored information regarding the plan of care or to the stored caregiver information comprises determining whether:
a check-in event has a corresponding check-out event;
a check-out event has a corresponding check-in event;
a received voice input of a caregiver's voice matches a voice print of the caregiver or other previously recorded voice recordings stored in the one or more storage devices;
a received image of a caregiver's face matches an image of the caregiver stored in the one or more storage devices; or
received location information matches location information as indicated in the information regarding the plan of care stored in the one or more storage devices or in the caregiver information stored in the one or more storage devices.

12. The method of claim 10, wherein the notifying the user comprises at least one of:
presenting on a display screen a notification of the one or more discrepancies;
emailing a notification of the one or more discrepancies;
sending a text message regarding the one or more discrepancies;
sending an instant message regarding the one or more discrepancies; or
telephoning an automated message regarding the one or more discrepancies.

13. The method of claim 10, further comprising:
notifying the user to create updated check-in/check-out information; and
receiving information resolving the one or more discrepancies.

14. The method of claim 1, further comprising determining that a pattern related to the received check-in/check-out information is questionable and notifying a user of one or more discrepancies in the received check-in/check-out information.

15. The method of claim 1, further comprising generating payroll, caregiver payment, or wage information based on the received check-in/check-out information.

16. The method of claim 15, wherein:
the receiving the check-in/check-out information is performed by a first processor of the one or more hardware processors; and/or
the generating of payroll, caregiver payment, or wage information is performed by a second processor of the one or more hardware processors.

17. A system comprising:
at least one hardware processor that:
stores in one or more storage devices information regarding a plan of care for a care recipient and caregiver information associated with the plan of care;
receives check-in/check-out information initiated by the caregiver regarding caregiver services for the care recipient, which check-in/check-out information includes verification data based on voice matching or face matching; and
generates claim submission information based on the received check-in/check-out information.

18. The system of claim 17, wherein the at least one hardware processor also:
repeatedly receives location information from a global positioning system over a period of time
determines whether the location information matches a predetermined area; and
generates an alert and/or checks out the caregiver if it is determined that the location information does not match the predetermined area.

19. The system of claim 17, wherein the at least one hardware processor also generates claim submission information that comprises generating claim submission information in one of a coma separated values (CSV) file format, a spreadsheet, an image file format, or a page file format.

20. The system of claim 17, wherein the at least one hardware processor also transmits the claim submission information to an insurer or payer of the caregiver services.

21. The system of claim 20, wherein the at least one hardware processor also transmits the claim submission information via one of fax, secure copy (SCP) protocol, hypertext transfer protocol secure (HTTPS), file transfer protocol (FTP), or direct electronic interface.

22. The system of claim 17, wherein the at least one hardware processor also stores in the one or more storage devices information including at least one of a care recipient identifier, a number of caregiver hours to be worked in a day, a number of caregiver days to be worked in a week, or an indication of at least one type of activity of daily living with which the care recipient is to be assisted.

23. The system of claim 17, wherein the at least one hardware processor also determines a number of hours worked and compares the number of hours worked to a planned number of hours to be worked.

24. The system of claim 17, wherein the at least one hardware processor also stores in one or more storage devices at least one of a caregiver identifier, a voice print of the caregiver's voice, a previous recording of the caregiver's voice, or an image of the caregiver's face.

25. The system of claim 17, wherein the at least one hardware processor also:
receives check-in time information from the caregiver regarding the caregiver services, the check-in time information including at least one of a caregiver identifier, a voice input comprising the caregiver's spoken name, another voice input compared to the voice print, an image of the caregiver's face; or
receives check-out time information from the caregiver regarding the caregiver services, the check-out time information including at least one of a caregiver identifier, a voice input comprising the caregiver's spoken name, another voice input compared to the voice print, an image of the caregiver's face, or information about services provided.

26. The system of claim 17, wherein the at least one hardware processor also determines that the received check-in/check-out information is not complete or does not conform to the stored information regarding the plan of care or to the stored caregiver information and notifies a user of one or more discrepancies in the received check-in/check-out information.

27. The system of claim 26, wherein the at least one hardware processor also determines that the received check-in/check-out information is not complete or does not conform to the stored information regarding the plan of care or to the stored caregiver information comprises determining whether:
a check-in event has a corresponding check-out event;
a check-out event has a corresponding check-in event;
a received voice input of a caregiver's voice matches a voice print of the caregiver or other previously recorded voice recordings stored in the one or more storage devices;
a received image of a caregiver's face matches an image of the caregiver stored in the one or more storage devices; or
received location information matches location information as indicated in the information regarding the plan of care stored in the one or more storage devices or in the caregiver information stored in the one or more storage devices.

28. The system of claim 26, wherein the at least one hardware processor, in notifying the user, also:
presents on a display screen a notification of the one or more discrepancies;
emails a notification of the one or more discrepancies;
sends a text message regarding the one or more discrepancies;
sends an instant message regarding the one or more discrepancies; and/or
telephones an automated message regarding the one or more discrepancies.

29. The system of claim 26, wherein the at least one hardware processor also:
notifies the user to create updated check-in/check-out information; and
receives information resolving the one or more discrepancies.

30. The system of claim 17, wherein the at least one hardware processor also determines that a pattern related to the received check-in/check-out information is questionable and notifies a user of one or more discrepancies in the received check-in/check-out information.

31. The system of claim 17, wherein the at least one hardware processor also generates payroll, caregiver payment, or wage information based on the received check-in/check-out information.

32. The system of claim 31, wherein:
a first processor of the one or more hardware processors receives the check-in/check-out information; and/or
a second processor of the one or more hardware processors generates payroll, caregiver payment, or wage information.

33. A non-transitory computer-readable medium containing computer-executable instructions that, when executed by a processor, cause the processor to perform a method comprising:
storing in one or more storage devices information regarding a plan of care for a care recipient and caregiver information associated with the plan of care;
receiving at one or more hardware processors check-in/check-out information initiated by the caregiver regarding caregiver services for the care recipient, which check-in/check-out information includes verification data based on voice matching or face matching; and
generating claim submission information based on the received check-in/check-out information.

34. The non-transitory computer-readable medium of claim 33, wherein the method further comprises:
repeatedly receiving location information from a global positioning system over a period of time;
determining whether the location information matches a predetermined area; and
generating an alert and/or checking out the caregiver if it is determined that the location information does not match the predetermined area.

35. The non-transitory computer-readable medium of claim 33, wherein generating claim submission information comprises generating claim submission information in one of a coma separated values (CSV) file format, a spreadsheet, an image file format, or a page file format.

36. The non-transitory computer-readable medium of claim 33, wherein the method further comprises transmitting the claim submission information to an insurer or payer of the caregiver services.

37. The non-transitory computer-readable medium of claim 36, wherein the method further comprises transmitting the claim submission information via one of fax, secure copy (SCP) protocol, hypertext transfer protocol secure (HTTPS), file transfer protocol (FTP), or direct electronic interface.

38. The non-transitory computer-readable medium of claim 33, wherein the storing in one or more storage devices of information regarding a plan of care comprises storing in one or more storage devices information including at least one of a care recipient identifier, a number of caregiver hours to be worked in a day, a number of caregiver days to be worked in a week, or an indication of at least one type of activity of daily living with which the care recipient is to be assisted.

39. The non-transitory computer-readable medium of claim 33, wherein the method further comprises determining a number of hours worked and comparing the numbers of hours worked to a planned number of hours to be worked.

40. The non-transitory computer-readable medium of claim 33, wherein the storing in one or more storage devices of caregiver information comprises storing in one or more storage devices at least one of a caregiver identifier, a voice print of the caregiver's voice, a previous recording of the caregiver's voice, or an image of the caregiver's face.

41. The non-transitory computer-readable medium of claim 33, wherein the receiving at one or more hardware processors check-in/check-out information comprises at least one of:
receiving at the one or more hardware processors check-in time information from the caregiver regarding the caregiver services, the check-in time information including at least one of a caregiver identifier, a voice input comprising the caregiver's spoken name, another voice input compared to the voice print, an image of the caregiver's face; or
receiving at the one or more hardware processors check-out time information from the caregiver regarding the caregiver services, the check-out time information including at least one of a caregiver identifier, a voice input comprising the caregiver's spoken name, another voice input compared to the voice print, an image of the caregiver's face, or information about services provided.

42. The non-transitory computer-readable medium of claim 33, wherein the method further comprises determining that the received check-in/check-out information is not complete or does not conform to the stored information regarding the plan of care or to the stored caregiver information and notifying a user of one or more discrepancies in the received check-in/check-out information.

43. The non-transitory computer-readable medium of claim 42, wherein the determining that the received check-in/check-out information is not complete or does not conform to the stored information regarding the plan of care or to the stored caregiver information comprises determining whether:
a check-in event has a corresponding check-out event;
a check-out event has a corresponding check-in event;
a received voice input of a caregiver's voice matches a voice print of the caregiver or other previously recorded voice recordings stored in the one or more storage devices;
a received image of a caregiver's face matches an image of the caregiver stored in the one or more storage devices; or
received location information matches location information as indicated in the information regarding the plan of care stored in the one or more storage devices or in the caregiver information stored in the one or more storage devices.

44. The non-transitory computer-readable medium of claim 42, wherein the notifying the user comprises at least one of:
presenting on a display screen a notification of the one or more discrepancies;
emailing a notification of the one or more discrepancies;
sending a text message regarding the one or more discrepancies;
sending an instant message regarding the one or more discrepancies; or
telephoning an automated message regarding the one or more discrepancies.

45. The non-transitory computer-readable medium of claim 42, wherein the method further comprises:
notifying the user to create updated check-in/check-out information; and
receiving information resolving the one or more discrepancies.

46. The non-transitory computer-readable medium of claim 33, wherein the method further comprises determining that a pattern related to the received check-in/check-out information is questionable and notifying a user of one or more discrepancies in the received check-in/check-out information.

47. The non-transitory computer-readable medium of claim 33, wherein the method further comprises generating payroll, caregiver payment, or wage information based on the received check-in/check-out information.

48. The non-transitory computer-readable medium of claim 47, wherein:
the receiving the check-in/check-out information is performed by a first processor of the one or more hardware processors; and/or
the generating of payroll, caregiver payment, or wage information is performed by a second processor of the one or more hardware processors.
